(19) United States
(12) Patent Application Publication
(10) Pub. No.: US 2007/0195231 A1
(43) Pub. Date: Aug. 23, 2007

(54) LIQUID CRYSTAL DEVICE AND ELECTRONIC APPARATUS

(75) Inventors: Mitsuru KURIBAYASHI, Chino (JP); Kazumi ARUGA, Fujimi (JP); Akira INAGAKI, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/620,808

(22) Filed: Jan. 8, 2007

(30) Foreign Application Priority Data
Feb. 20, 2006 (JP) 2006-042007

(51) Int. Cl. G02F 1/1335

(52) U.S. Cl. 349/106

(57) ABSTRACT

A liquid crystal device includes an electrode substrate including a plurality of pixel electrodes; a counter substrate facing the electrode substrate; a color filter including a color element facing each of the plurality of pixel electrodes; liquid crystal supported between the electrode substrate and the counter substrate; and an alignment controlling means extending on a face, which contacts the liquid crystal, of at least one of the electrode substrate and the counter substrate. The color element has four or more colors, and an extending direction of the alignment controlling means formed on a position corresponding to the color element of any color of at least three predetermined colors of the four or more colors is determined in each color, and is different in each color.

### BACKGROUND

1. Technical Field

The present invention relates to a liquid crystal device and an electronic apparatus equipped with the liquid crystal device.

2. Related Art

Liquid crystal devices such as a liquid crystal display (LCD) have been conventionally known. The LCD includes a pixel electrode in each pixel which is a unit constituting an image, and direction of a liquid crystal in the LCD is aligned by applying voltage to the pixel electrode. The LCD equals to a cathode ray tube (CRT) on an image quality such as a contrast or color reproducibility in a front vision. However, the image quality has viewing angle dependences, so that the viewing angle of the LCD is narrower than that of the CRT. Japanese Patent No. 2947350 is a first example of the related art. The first example discloses a liquid crystal display which can widen a viewing angle by controlling an alignment direction of liquid crystal with an alignment controlling means (domain regulating means).

In addition, in order to display a color image, respective filters of red, green, and blue, which are the light's three primary colors, for example, are provided to respective pixels. Pixels provided with respective filters of red, green, and blue are pixels of the colors. Further, there is a unit that is composed of pixels including at least one each pixel of red, green, and blue and constitutes a color image (hereinafter, referred to as “picture element”). A color of a picture element is reproduced by changing respective intensity of red, green, and blue in the unit. In order to expand a reproducible color area, multi-color filters provided with not only filters of red, green, and blue, but also filters of other colors is used. Multi-color filters are six-color filters, four-complementary-color filters, and the like. Six-color filters are provided with filters of cyan, magenta, and yellow which are complementary colors of red, green, and blue as well as filters of red, green, blue. Four-complementary-color filters are provided with a filter of green as well as filters of cyan, magenta, and yellow. JP-A-2002-286927 is a second example of the related art. The second example discloses various kinds of multi-color filters and an electro-optic panel equipped with multi-color filters.

However, the alignment controlling means (domain regulating means) disclosed in the first example is not applicable to a liquid crystal display equipped with multi-color filters as disclosed in the second example. An alignment controlling means is provided to a filter surface so as to control an alignment direction of liquid crystal, providing sufficient amount of light in a wider range (viewing angle). In a part, of which the viewing angle is widened by the alignment controlling means, that is a part where sufficient amount of light can be obtained because the amount of light increases due to the alignment controlling means, the effects of the alignment controlling means to the increase of the amount of light are even. Even though the increased amount of light is even, if the light transmits through a filter, the effect of the increased amount of light to the color balance is different depending on the filter color. The effect to the color balance is different depending on the effective areas through which pixel light transmits, as well. That is, in multi-color filters, when a viewing angle is widened in each color with a use of an alignment controlling means, an appropriate color balance is not always obtained in the widened viewing angle.

### SUMMARY

An advantage of the present invention is to provide a liquid crystal device equipped with multi-color filters and an electronic apparatus equipped with the liquid crystal device. The liquid crystal device not only widens a viewing angle with a use of an alignment controlling means but also attains appropriate color balance.

A liquid crystal device according to a first aspect of the invention includes an electrode substrate including a plurality of pixel electrodes; a counter substrate facing the electrode substrate; a color filter including a color element facing each of the plurality of pixel electrodes; liquid crystal supported between the electrode substrate and the counter substrate; and an alignment controlling means extending on a face, which contacts the liquid crystal, of at least one of the electrode substrate and the counter substrate. The color element has four or more colors, and an extending direction of the alignment controlling means formed on a position corresponding to the color element of any color of at least three predetermined colors of the four or more colors is determined in each color, and is different in each color.

A liquid crystal device equipped with multi-color filters changes respective intensities of colors of a unit (hereinafter, referred to as “picture element”) composed of pixels including at least one each pixel, having a color element, of colors to be equipped and constituting a color image, thereby providing a color of the color image. The liquid crystal device can reproduce a color inside of a polygon obtained by connecting dots of the colors included in the multi-color filters on a gamut. If there are pixels of three colors, a color inside of a triangle obtained by connecting dots of the colors on a gamut.

By providing an alignment controlling means on a face of a color element, an alignment direction of liquid crystal can be regulated to provide sufficient amount of light in a wider range (viewing angle). In a part, widened by the alignment controlling means, of the viewing angle, that is a part where sufficient amount of light can be obtained because the amount of light increases due to the alignment controlling means, the effect of the alignment controlling means to the increase of the amount of light is even. Even though the increased amount of light is even, when the light transmits through a color element, the effect of the increased amount of light to the color balance is different depending on the color of the color element.

According to the liquid crystal device of the aspect of the invention, extending directions of alignment controlling means formed on positions corresponding to color elements of at least three colors constituting a picture element are different from each other. Extending directions of alignment controlling means in pixels of at least three colors constituting a picture element are set in each color, thereby being able to appropriately set an alignment direction of liquid crystal, which is regulated by the extending direction of the alignment controlling means, in corresponding to each color, in pixels of at least three colors. This can widen the viewing angle by regulating the alignment direction of the liquid crystal by the alignment controlling means and realize an appropriate color balance in the widened viewing angle by setting the alignment direction in each color.

It is preferable that an extending direction of the alignment controlling means formed on a position corresponding to the color element of a color other than the predetermined colors be determined in each color, be different in each color, and be different from an extending direction of the alignment controlling means formed on the position corresponding to the color element of any color of the predetermined colors, in the liquid crystal device.

According to the structure of the liquid crystal device, extending directions of alignment controlling means formed on positions corresponding to the color elements of respective colors constituting a picture element are different from each other. Extending directions of alignment controlling means in pixels of respective colors constituting a picture element are set in each color, thereby being able to appropriately set an alignment direction of liquid crystal, which is regulated by an extending direction of the alignment controlling means, in corresponding to each color, in respective pixels. This can widen the viewing angle by regulating the alignment direction of the liquid crystal by the alignment controlling means and realize an appropriate color balance in the widened viewing angle by setting the alignment direction in each color.

It is preferable that the predetermined colors be red, green, and blue which are three primary colors, in the liquid crystal device.

Most liquid crystal devices equipped with multi-color filters include pixels having color elements of respective colors of the light's three primary colors by which a wide color reproduction range can be obtained by few colors. According to the structure, extending directions of alignment controlling means formed on positions corresponding to the color elements of the light's three primary colors constituting a picture element are different from each other. Extending directions of alignment controlling means in pixels of respective light's three primary colors constituting a picture element are set in each color, thereby being able to appropriately set an alignment direction of liquid crystal, which is regulated by extending directions of the alignment controlling means, in corresponding to each color, in pixels of the light's three primary colors. This can widen the viewing angle by regulating the alignment direction of the liquid crystal of pixels having color elements of respective colors of the light's three primary colors by the alignment controlling means, and realize an appropriate color balance in the widened viewing angle by setting the alignment directions in respective colors.

It is preferable that an extending direction of the alignment controlling means formed on a position corresponding to the color element of a color other than the three primary colors be determined in each color, and different in each color.

According to the structure of the liquid crystal device, extending directions of alignment controlling means formed on positions corresponding to the color elements, constituting a picture element, of colors other than the light's three primary colors are different from each other. Extending directions of alignment controlling means in pixels, constituting a picture element, of respective colors other than the light's three primary colors are set in each color, thereby being able to appropriately set an alignment direction of liquid crystal, which is regulated by an extending direction of the alignment controlling means, in corresponding to each color, in pixels of colors other than the light's three primary colors. This can widen the viewing angle by controlling the alignment direction of liquid crystal of pixels having the color elements of respective colors other than the light's three primary colors by the alignment controlling means, and realize an appropriate color balance in the widened viewing angle by setting an alignment direction in each color, as well as being able to realize an appropriate color balance in the widened viewing angle in the light's three primary colors.

It is preferable that the predetermined colors be any of cyan, magenta, and yellow which are complementary colors of red, green, and blue which are the three primary colors.

Liquid crystal devices equipped with a complementary-color filter for realizing a liquid crystal device providing a brighter image is known, in the liquid crystal devices, the complementary-color filter includes color elements of complementary colors of the light's three primary colors. The complementary colors can provide a wide color reproduction range equal to the one of the light's three primary colors, and a brighter image due to their lighter colors than the light's three primary colors. According to the structure, extending directions of alignment controlling means formed on positions corresponding to the color elements, constituting a picture element, of the complementary colors of the light's three primary colors are different from each other. Extending directions of alignment controlling means in pixels, constituting a picture element, of the complementary colors of the light's three primary colors are set in each color, thereby being able to appropriately set an alignment direction of liquid crystal, which is regulated by extending directions of the alignment controlling means, in corresponding to each color, in pixels of respective complementary colors of the light's three primary colors. This can widen the viewing angle by regulating the alignment direction of the liquid crystal of pixels having color elements of respective colors of the complementary colors of the light's three primary colors by the alignment controlling means and realize an appropriate color balance in the widened viewing angle by setting the alignment directions in respective colors.

It is preferable that an extending direction of the alignment controlling means formed on a position corresponding to the color element of a color other than the complementary colors of the three primary colors be determined in each color, and different in each color.

According to the structure, extending directions of alignment controlling means formed on positions corresponding to the color elements, constituting a picture element, of colors other than the complementary colors of the light's three primary colors are different from each other. Extending directions of alignment controlling means in pixels, constituting a picture element, of respective colors other than the complementary colors of the light's three primary colors are set in each color, thereby being able to appropriately set an alignment direction of liquid crystal, which is regulated by extending directions of the alignment controlling means, in corresponding to each color, in pixels of respective colors other than the complementary colors of the light's three primary colors. This can widen the viewing angle by controlling the alignment direction of liquid crystal of pixels having the color elements of respective colors other than the complementary colors of the light's three primary colors by the alignment controlling means, and realize an appropriate color balance in the widened viewing angle by setting an alignment direction in each color, as well as being able to realize an appropriate color balance in the widened viewing angle due to the complementary colors of the light's three primary colors.

A liquid crystal device according to a second aspect of the invention includes an electrode substrate including a plurality of pixel electrodes; a counter substrate facing the electrode substrate; a color filter including a color element facing each of the plurality of pixel electrodes; liquid crystal supported between the electrode substrate and the counter substrate; and an alignment controlling means extending on a face, the face contacting the liquid crystal, of at least one of the electrode substrate and the counter substrate. The color element respectively has a color of red, green and blue which are three primary colors, and cyan, magenta, and yellow which are complementary colors of the three primary colors. An extending direction of the alignment controlling means formed on a position corresponding to the color element of any color of the three primary colors is determined in each color, and different in each color. An extending direction of the alignment controlling means formed on a position corresponding to the color element of any color of the complementary colors of the three primary colors is determined in each color, and different in each color.

By providing an alignment controlling means on a face of a color element, an alignment direction of liquid crystal can be regulated to provide sufficient amount of light in a wider range (viewing angle). In a part, widened by the alignment controlling means, of the viewing angle, that is a part where sufficient amount of light can be obtained because the amount of light increases due to the alignment controlling means, the effect of the alignment controlling means to the increase of the amount of light is even. Even though the increased amount of light is even, if the light transmits through a color element, the effect to the color balance is different in each color of the color element.

According to the liquid crystal device, extending directions of alignment controlling means formed on positions corresponding to the color elements, constituting a picture element, of respective light's three primary colors are different from each other. Extending directions of alignment controlling means in pixels, constituting a picture element, of respective light's three primary colors are set in each color, thereby being able to appropriately set an alignment direction of liquid crystal, which is regulated by an extending direction of the alignment controlling means, in corresponding to each color, in pixels of the light's three primary colors. This can widen the viewing angle by regulating the alignment direction of the liquid crystal of pixels including the color elements of respective colors of the three primary colors by the alignment controlling means, and realize an appropriate color balance in a color inside of a triangle formed by the light's three primary colors on a gamut, in the widened viewing angle by setting the alignment directions in each color. In the same way, the alignment controlling means regulate the alignment directions of the liquid crystal of pixels including the color elements of respective colors of the complementary colors of the three primary colors to widen the viewing angle, and setting the alignment directions in each color can realize an appropriate color balance in a color inside of a triangle formed by the light's three primary colors on a gamut, in the widened viewing angle.

A liquid crystal device according to a third aspect of the invention includes an electrode substrate including a plurality of pixel electrodes; a counter substrate facing the electrode substrate; a color filter including a color element facing each of the plurality of pixel electrodes; liquid crystal supported between the electrode substrate and the counter substrate; and an alignment controlling means extending on a face, the face contacting the liquid crystal, of at least one of the electrode substrate and the counter substrate. The color element respectively has a color of red, green and blue which are three primary colors, and cyan, magenta, and yellow which are the complementary colors of the three primary colors. An extending direction of the alignment controlling means formed on a position corresponding to the color element is determined in each color, and an extending direction of the alignment controlling means formed on a position corresponding to the color element of a first color is different from an extending direction of the alignment controlling means formed on a position corresponding to the color element of a second color which is in a complementary color relation to the first color.

According to the liquid crystal device, extending directions of alignment controlling means formed on positions corresponding to color elements which are in mutually complementary color relation are different from each other. Extending directions of the alignment controlling means in pixels of colors which are in mutually complementary color relation and constitute a picture element is set in each color, thereby being able to appropriately set an alignment direction of liquid crystal, which is regulated by the extending direction of the alignment controlling means, in corresponding to each color, in pixels of colors which are in mutually complementary color relation. This can widen the viewing angle by regulating the alignment direction of the liquid crystal by the alignment controlling means and realize an appropriate color balance in colors in mutually complementary color relation, in the widened viewing angle by setting the alignment direction in each color.

A liquid crystal device according to a fourth aspect of the invention includes an electrode substrate including a plurality of pixel electrodes; a counter substrate facing the electrode substrate; a color filter including a color element facing each of the plurality of pixel electrodes; liquid crystal supported between the electrode substrate and the counter substrate; and an alignment controlling means extending on a face, the face contacting the liquid crystal, of at least one of the electrode substrate and the counter substrate. The color element includes a first color element having a first area of an effective area through which light transmits, and a second color element having a second area of the effective area. An extending direction of the alignment controlling means formed on a position corresponding to at least one of the first color element and the second color element is determined in each color, and different in each color of the first color element or in each color of the second color element.

By providing an alignment controlling means on a face of a color element, an alignment direction of liquid crystal can be regulated to provide sufficient amount of light in a wider range (viewing angle). In a part, widened by the alignment controlling means, of the viewing angle, that is a part where sufficient amount of light can be obtained because the amount of light increases due to the alignment controlling means, the effect of the alignment controlling means to the increase of the amount of light is even. Even though the increased amount of light is even, when the light transmits through a color element, the effect of the increased amount of light to the color balance is different in each effective area, through which light transmits, of the color element.

According to the liquid crystal device, between colors of color elements having identical effective areas, extending directions of the alignment controlling means formed on positions corresponding to the color elements, constituting a picture element, of respective colors are different from each other. Extending directions of alignment controlling means in pixels respectively having identical effective areas are set in each color, thereby being able to adjust to appropriately set an alignment direction of liquid crystal, which is regulated by extending directions of the alignment controlling means, in corresponding to each color, in pixels respectively having identical effective areas. This can widen the viewing angle by regulating the alignment directions of the liquid crystal of pixels including the color elements having identical effective areas by the alignment controlling means, and realize an appropriate color balance in a color inside of a polygon formed by colors of color elements having identical effective areas respectively on a gamut, in the widened viewing angle by setting the alignment directions in each color.

A liquid crystal device according to a fifth aspect of the invention includes an electrode substrate including a plurality of pixel electrodes; a counter substrate facing the electrode substrate; a color filter including a color element facing each of the plurality of pixel electrodes; liquid crystal supported between the electrode substrate and the counter substrate; and an alignment controlling means extending on a face, the face contacting the liquid crystal, of at least one of the electrode substrate and the counter substrate. The color element includes a first color element having a first area of an effective area through which light transmits, and a second color element having a second area of the effective area. An extending direction of the alignment controlling means formed on a position corresponding to the first color element or the second color element is determined in each color, and an extending direction of the alignment controlling means formed on a position corresponding to the first color element and an extending direction of the alignment controlling means formed on a position corresponding to the second color element are different from each other.

In multi-color filters, an effective area is changed in corresponding to a color of a color element, in order to strike an appropriate color balance. According to the liquid crystal device, between color elements having different effective areas from each other, extending directions of alignment controlling means formed on positions corresponding to the color elements of respective colors constituting a picture element are different from each other. Extending directions of alignment controlling means in pixels having different effective areas from each other are set in each effective area, thereby being able to adjust to appropriately set an alignment direction of liquid crystal, which is regulated by extending directions of the alignment controlling means, in corresponding to the effective areas, in pixels having different effective areas from each other. This can widen the viewing angle by regulating the alignment direction of the liquid crystal of pixels of color elements having different effective areas by the alignment controlling means, and realize an appropriate color balance in the widened viewing angle by setting the alignment direction in corresponding to the effective area of each color element in respective colors in which an appropriate color balance can be provided by changing the effective area.

It is preferable that an extending direction of the alignment controlling means formed on a position corresponding to the color element be determined in each color, and is different in each color of the color element.

According to the structure, extending directions of alignment controlling means formed on positions corresponding to the color elements of respective colors constituting a picture element are different from each other. Extending directions of alignment controlling means in pixels, constituting a picture element, of respective colors are set in each color, thereby being able to appropriately set an alignment direction of liquid crystal, which is regulated by an extending direction of the alignment controlling means, in corresponding to each color, in respective pixels. This can widen the viewing angle by regulating the alignment direction of the liquid crystal by the alignment controlling means and realize an appropriate color balance in the widened viewing angle by setting the alignment direction in each color.

It is preferable that an extending direction of the alignment controlling means include a first extending direction and a second extending direction, and the alignment controlling means corresponding to the single color element include both of the alignment controlling means extending in the first extending direction and the alignment controlling means extending in the second extending direction, in the liquid crystal device.

Providing an alignment controlling means extending in one direction can widen a viewing angle in one direction. Examples of the viewing angle in one direction include viewing angles in a left-right direction, an up-down direction, and an oblique direction, in a liquid crystal device. In the structure, the viewing angle in two directions can be widened by the alignment controlling means extending in two directions.

It is preferable that the alignment controlling means be a protrusion formed on a face contacting the liquid crystal or a concave part formed on a face contacting the liquid crystal, in the liquid crystal device.

In the structure, the protrusion or the concave part works as the alignment controlling means regulating a direction in which the liquid crystal inclines. In the liquid crystal device in a state that no driving voltage is applied to the pixel electrode by which the liquid crystal is aligned, liquid crystal molecules of the liquid crystal align perpendicular to an alignment film. If a protrusion or a concave part is formed on an even face contacting a liquid crystal layer, the liquid crystal molecules contacting a lateral face of the protrusion or the concave part align perpendicular to the lateral face of the protrusion or the concave part, aligning with an inclination to the even face. If a predetermined driving voltage is applied to the pixel electrode, the liquid crystal molecules turn to align perpendicular to a magnetic field. In this time, first liquid crystal molecules which incline in a state no driving voltage is applied incline further to turn, and second liquid crystal molecules adjacent to the first liquid crystal molecules are affected and incline to turn in the same direction as the first liquid crystal molecules. This renders inclination directions of the liquid crystal molecules uniform.

It is preferable that one of the protrusion and the concave part, or both of the protrusion and the concave part be provided in corresponding to each of the color element.

It is preferable that the concave part be formed by providing a slit to the pixel electrode.

In the structure, just by forming a slit on the pixel electrode, the concave part can be formed without any necessity to supply other material for forming the concave part.

It is preferable that the alignment controlling means be a gap between the pixel electrodes adjacent each other.

In a liquid crystal device of an in-plane switching (IPS) system, a pixel electrode is provided to one of faces supporting and contacting a liquid crystal layer, and at least two individual pixel electrodes are provided in one pixel. If the driving voltage is applied to the pixel electrodes in one pixel, the liquid crystal molecules, which align approximately perpendicular to a pixel electrode face in a state that no driving voltage is applied, turn to be approximately parallel to the pixel electrode face. In this case, the liquid crystal molecules which have aligned approximately perpendicular to the pixel electrode face incline to turn to the two pixel electrodes to which driving voltage is applied, so that a gap between the pixel electrodes works as the alignment controlling means.

An electronic apparatus according to the aspect of the invention includes the liquid crystal device according to the first aspect.

According to the electronic apparatus of the aspect of the invention, a preferable electronic apparatus can be realized by providing a liquid crystal device which can widen the viewing angle by regulating the alignment direction of the liquid crystal by the alignment controlling means, and realize an appropriate color balance in the widened viewing angle.

### BRIEF DESCRIPTION OF THE DRAWINGS

The invention will be described with reference to the accompanying drawings, wherein like numbers reference like elements.

FIG. 1 is an exploded perspective view of a liquid crystal display according to the invention.

FIG. 2 is a sectional view showing the liquid crystal display taken along the line A-A of FIG. 1.

FIG. 3A is a schematic view showing a plane structure of a color filter. FIG. 3B is a schematic view showing a plane structure of a mother substrate provided with a plurality of second substrates.

FIG. 4A a plane view showing an arrangement example of a color element of a four-color filter. FIGS. 4B and 4C are plane views showing arrangement examples of color elements of a six-color filter.

FIGS. 5A and 5B are schematic views showing an outline of a droplet discharge head.

FIG. 6A is a perspective view showing a structure of a droplet discharge head. FIG. 6B is a sectional view showing a detailed structure of a discharge nozzle part of the droplet discharge head.

FIG. 7 is a flow chart showing processes of manufacturing a color filter substrate.

FIGS. 8A to 8G are sectional views schematically showing processes of manufacturing a color filter substrate.

FIG. 9 is a flow chart showing processes of manufacturing a liquid crystal display.

FIGS. 10A to 10C are sectional views schematically showing processes of forming the second substrate.

FIG. 11 is a sectional view of a liquid crystal panel showing an alignment direction of liquid crystal when no driving voltage is applied.

FIG. 12 is a plan view showing an extending direction of a protrusion in a picture element of a four-color filter.

FIG. 13 is a plan view showing an extending direction of a protrusion in a picture element of a six-color filter.

FIG. 14 is a plan view showing an extending direction of a protrusion in a picture element of a six-color filter.

FIG. 15 is a plan view showing an extending direction of a protrusion in a picture element of a six-color filter.

FIG. 16A is a sectional view showing an alignment direction of liquid crystal in a liquid crystal panel provided with a concave part on a face contacting a liquid crystal layer in a state that no driving voltage is applied. FIG. 16B is a sectional view showing an alignment direction of liquid crystal in a liquid crystal panel provided with a protrusion on a second substrate and a concave part on a first substrate contacting a liquid crystal layer in a state that no driving voltage is applied.

FIG. 17 is an external perspective view showing a large-sized liquid crystal television which is an example of the electronic apparatus.

### DESCRIPTION OF EXEMPLARY EMBODIMENTS

Now, a liquid crystal display which is an example of a liquid crystal device and an electronic apparatus equipped with a liquid crystal display according to exemplary embodiments of the invention will be described with reference to the accompanying drawings. A liquid crystal display illustrated here is a liquid crystal display of multi-domain vertical alignment (MVA) system using a color filter substrate having an alignment layer for vertical alignment. The scale of the members and layers in the drawings used for a description is adequately changed so that they can be recognized.

### First Embodiment

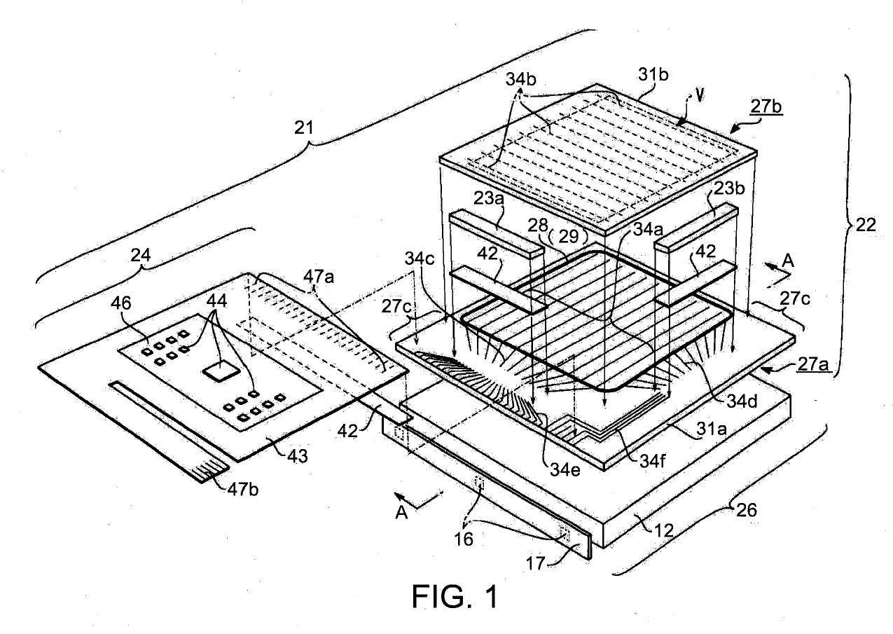

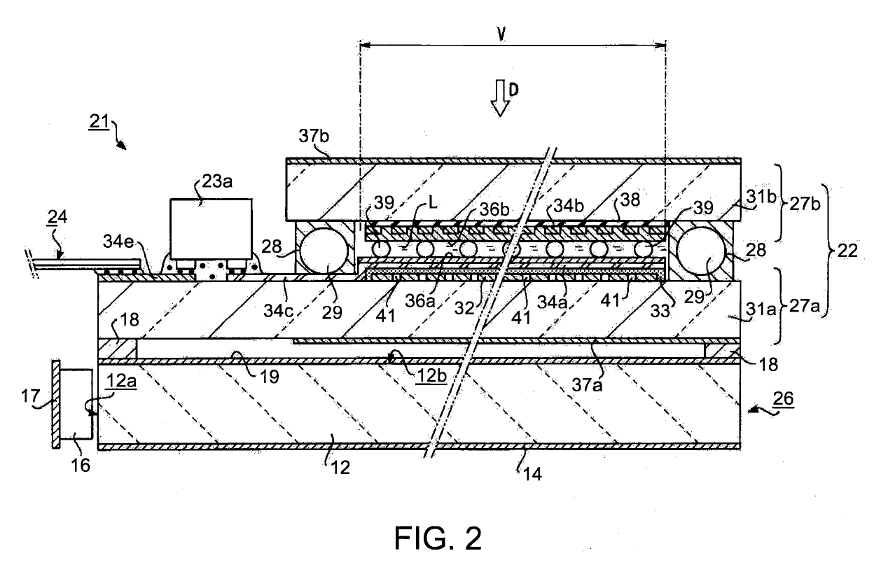

A structure of a liquid crystal display is first described. FIG. 1 is an exploded perspective view showing a liquid crystal display according to a first embodiment of the invention. FIG. 2 is a sectional view showing the liquid crystal display taken along the line A-A of FIG. 1. In FIG. 1, a liquid crystal display 21 includes a liquid crystal panel 22 which is mounted with a liquid crystal driving IC 23a and a liquid crystal driving IC 23b as semiconductor chips, coupled with a flexible printed circuit (FPC) 24 as a wiring connection element, and provided with an illuminator 26 as a backlight on the rear surface thereof.

The liquid crystal panel 22 is formed by joining a first substrate 27a and a second substrate 27b together while interposing a sealant 28 in between. The sealant 28 is formed by allowing epoxy resin to adhere to an inner surface of the first substrate 27a or the second substrate 27b in a circular shape by screen printing, for example. The sealant 28 includes conductive members 29 (refer to FIG. 2) which is made of conductive material and formed spherically or cylindrically in a dispersion state.

In FIG. 2, the first substrate 27a includes a base member 31a being plate-like and made of transparent glass, transparent plastic, or the like. The base member 31a has an arrangement in which layers are stocked on the inner surface (upper surface of FIG. 2) thereof in the order of a reflecting film 32, an insulating film 33, first electrodes 34a, and an alignment film 36a. The first electrodes 34a are formed in stripe fashion when viewed as a direction of an arrow D. In addition, a polarizing plate 37a is attached by sticking or the like on the outer surface (lower surface of FIG. 2) of the base member 31a.

In order to show an alignment of the first electrodes 34a in a way easy to understand, each interval of stripes of the first electrodes 34a is drawn much broader than it really is, and therefore the number of the first electrodes 34a is small, in the drawing. However, more first electrodes 34a are formed on the base member 31a, in practice. The first substrate 27a represents an electrode substrate or a counter substrate.

In FIG. 2, the second substrate 27b includes a base member 31b being plate-like and made of transparent glass, transparent plastic, or the like. The base member 31b has an arrangement in which layers are stocked on the inner surface (lower surface of FIG. 2) thereof in the order of a color filter 38, second electrodes 34b, and an alignment film 36b. The second electrodes are formed in a direction perpendicular to the first electrode 34a in a stripe shape when viewed in a direction of the arrow D (refer to FIG. 1). In addition, a polarizing plate 37b is attached by sticking or the like on the outer surface (upper surface of FIG. 2) of the base member 31b.

In order to show an alignment of the second electrodes 34b in a way easy to understand, just like a case of the first electrodes 34a, each interval of stripes of the second electrodes 34b is drawn much broader than it really is, and therefore the number of the second electrodes 34b is small, in the drawing. However, more second electrodes 34b are formed on the base member 31b, in practice. The second substrate 27b corresponds to a counter substrate or an electrode substrate.

In FIG. 2, liquid crystal L is sealed in a gap surrounded by the first substrate 27a, the second substrate 27b, and the sealant 28, i.e. a cell gap. In the inner surface of the first substrate 27a or the second substrate 27b, a lot of spacers 39 which are tiny and spherical are dispersed. Thus, the cell gap has spacers 39 therein, so that a thickness thereof is kept even.

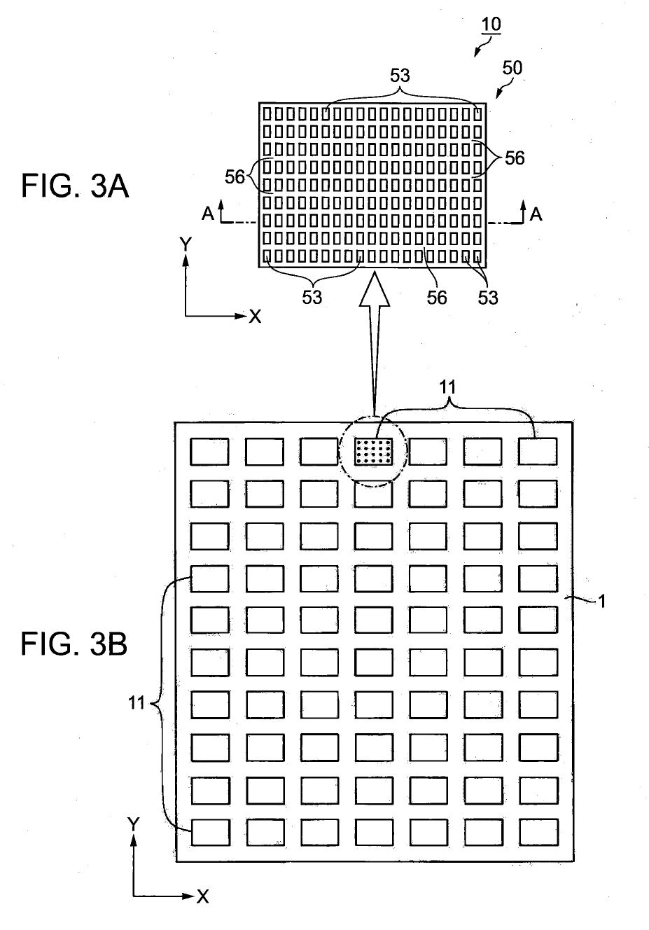

The first electrodes 34a are arranged perpendicular to the second electrodes 34b. When they are viewed in the direction of the arrow D in FIG. 2, their intersections are arranged in dot-matrix. Each of the intersections arranged in dot matrix constitutes one pixel. The color filter 38 includes color element regions (refer to FIG. 3) of which a color element 53 (refer to FIG. 3) overlaps with one pixel. For example, a color filter of three primary colors is formed by arranging respective colors of red (R), green (G), and blue (B) in a predetermined pattern such as a stripe arrangement, a delta arrangement, a mosaic arrangement, or the like when viewed in the direction of the arrow D. The above one pixel corresponds to each color element 53 of R, G, or B. Three pixels including respective pixels of three colors R, G, and B constitute one unit to be a minimum unit constituting a picture image (hereinafter, referred to as “picture element”).

A plurality of pixels arranged in dot matrix, that is, picture elements are selectively allowed to emit light, so as to display an image of a letter, a number, or the like on the exterior surface of the second substrate 27b of the liquid crystal panel 22. An area displaying an image as above is an effective pixel area. A planer rectangle area shown by an arrow V is the effective pixel area in FIGS. 1 and 2.

In FIG. 2, the reflecting film 32 is made of light reflective materials such as APC alloy, aluminum (Al), or the like, and apertures 41 are provided on positions corresponding to pixels which are intersections of the first electrodes 34a and the second electrodes 34b. That is, the apertures 41 are arranged in dot matrix like pixels when they are viewed in the direction of the arrow D in FIG. 2.

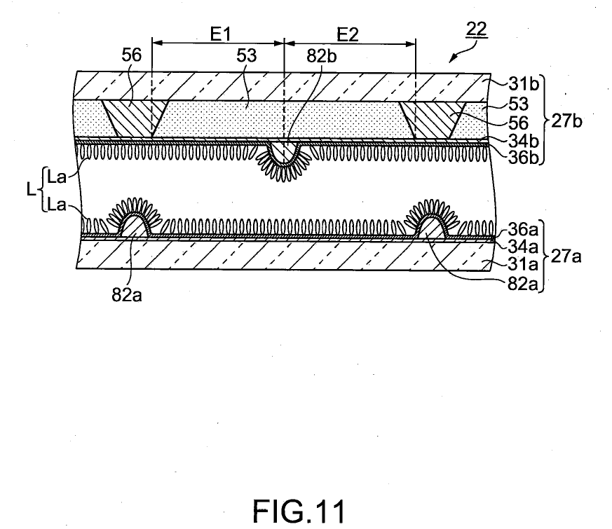

The first electrode 34a and the second electrode 34b are composed of conductive materials such as indium tin oxide (ITO), indium zinc oxide (IZO), and the like, and formed so as to have appropriate electric resistance and transparency. The film thickness is approximately 0.1 μm. In addition, the alignment films 36a and 3 Gb are formed by adhering polyimide resin in film form with an even thickness. In a liquid crystal display of MVA system, due to the alignment films 36a and 36b, a liquid crystal molecule La (refer to FIG. 11) of the liquid crystal L aligns nearly vertical to the alignment films 36a and 36b in a state that no voltage is applied to the first electrodes 34a and the second electrodes 34b. That is, the liquid crystal molecule L aligns nearly vertical to the surfaces of the first substrate 27a and the second substrate 27b.

In FIG. 1, the first substrate 27a has a larger area than the second substrate 27b. When they are joined together by the sealant 28, the first substrate 27a has an overhanging part 27c overhanging toward the outside of the second substrate 27b. The over hanging part 27c includes various kinds of wirings such as lead-out wirings 34c, lead-out wirings 34b, metal wirings 34e, metal wirings 34f, and the like in an appropriate pattern. The lead-out wirings 34c extend from the first electrodes 34a. The lead-out wirings 34d are electrically continuous with the second electrodes 34b on the second substrate 27b via the conductive member 29 (refer to FIG. 2) being inside of the sealant 28. The metal wirings 34e are coupled to an input bump of the liquid crystal driving IC 23a i.e. an input terminal. The metal wirings 34f are coupled to an input bump of the liquid crystal driving IC 23b.

In the embodiment, the lead-out wirings 34c extending from the first electrodes 34a and the lead-out wirings 34d electrically continuous with the second electrodes 34b are composed of ITO which is the same material as the one of the electrodes thereof, i.e. conductive oxides. The metal wirings 34e and 34f are made of metal materials having a low electric resistance value, for example APC alloy. The metal wirings 34e and 34f are wirings on the input side of the liquid crystal driving ICs 23a and 23b. APC alloy mainly includes Ag accompanying with Pd and Cu, for example; 98% Ag, 1% Pd and 1% Cu.

The liquid crystal driving ICs 23a and 23b are adhered and mounted on the surface of the overhanging part 27c by anisotropic conductive films (ACF) 42. That is, in the embodiment, a liquid crystal panel of chip on glass (COG) system is formed. The liquid crystal panel of COG system has a structure in which a semiconductor chip is directly mounted on a substrate. In the mounting structure of the COG system, input bumps of the liquid crystal driving ICs 23a and 23b are conductively connected with respective metal wirings 34e and 34f, and output bumps of the liquid crystal driving ICs 23a and 23b are conductively connected with the lead-out wirings 34c and 34d.

In FIG. 1, the FPC 24 includes a resin film 43 which is flexible, a circuit 46 having chip parts 44, and a metal wiring terminal 47a. The circuit 46 is mounted directly on the surface of the resin film 43 by electrically connecting method such as soldering or the like. Further, the metal wiring terminal 47a is composed of conductive materials such as APC alloy, Cr, Cu, and the like. A part having the metal wiring terminal 47a of the FPC 24 is connected with a part having the metal wirings 34e and 34f of the first substrate 27a by the ACF 42. Conductive particles included in the ACF 42 work to connect electrically the metal wirings 34e and 34f of the substrate with the metal wiring terminal 47a of the FPC 24.

An external connecting terminal 47b is formed on a side end, opposite to the metal wiring terminal 47a, of the FPC 24, and coupled to an external circuit which is not shown. On the basis of a signal transmitted from the external circuit, the liquid crystal driving ICs 23a and 23b are driven, providing a scanning signal to one of the liquid crystal driving ICs 23a and 23b and a data signal to the other of them. Therefore, each of the pixels arranged in dot matrix in the effective pixel area V is voltage controlled, so that an alignment of the liquid crystal L is controlled at each pixel.

A lighting system 26 functioning as so-called a backlight in FIG. 1 includes a light guide body 12, a diffusion sheet 19, a reflection sheet 14, and light emitting diode (LED) 16, as shown in FIG. 2. The light guide body 12 is composed of acrylic resin and the like. The diffusion sheet 19 is provided on a light emitting face 12b of the light guide body 12. The reflection sheet 14 is provided on an opposite face to the light emitting face 12b of the light guide body 12. The LED 16 is a light emitting source.

The LED 16 is supported by an LED substrate 17. The LED substrate 17 is attached to a supporting part (not shown) integrated with the light guide body 12, for example. Attaching the LED substrate 17 on the predetermined position of the supporting part disposes the LED 16 on a position facing a light accepting face 12a which is a side end face of the light guide body 12. Here, a reference number 18 denotes a buffer material for buffering a shock added to the liquid crystal panel 22.

If the LED 16 emits light, the light is taken from the light accepting face 12a into the inside of the light guide body 12. While the light reflects to the reflection sheet 14 and wall surfaces of the light guide body 12 and transmits, the light is emitted as a planner light from the diffusion sheet 19 via the light emitting face 12b.

Since the liquid crystal display 21 of the embodiment is composed as mentioned above, in a case where external light such as sunlight, indoor light, or the like is bright enough, the external light is taken from the second substrate 27b into the liquid crystal panel 22. After the light passes through the liquid crystal L, it reflects at the reflecting film 32 and is provided to the liquid crystal L again. The liquid crystal L is alignment-controlled at each pixel by voltage applied to the first electrode 34a and the second electrode 34b interposing the liquid crystal L in between, controlling a transmittance of the light provided to the liquid crystal L at each pixel. Brightness of each pixel of R, G, and B constituting one picture element determines a color of a picture element visually recognized from the outside of the liquid crystal panel 22. An image such as a letter, a number, or the like is displayed depending on a combination of the picture element. Thus, a reflective display is carried out.

On the other hand, in a case where an amount of external light is not enough, the LED 16 emits light and a planner light is emitted from the light emitting face 12b of the light guide body 12 so as to provide the light to the liquid crystal L via the apertures 41 opened on the reflecting film 32. At this time, in common with the reflective display, the provided light transmits with an individual transmittance at each pixel depending on the liquid crystal L which is alignment-controlled. Thus, a transmissive display is carried out.

Next, a structure of a color filter such as the color filter 38 provided to the second substrate 27b will be described. FIG. 3A is a schematic view showing a plane structure of a color filter according to one embodiment. In addition, FIG. 3B is a schematic view showing a plane structure of a mother substrate provided with a plurality of second substrates.

A color filter 50 has a structure as follows. A plurality of color element areas 52 are formed on a surface of a rectangular-shaped substrate, which is made of glass, plastic, or the like. The color element areas 52 are formed in dot pattern, i.e. in dot matrix in the embodiment. On the color element areas 52, color elements 53 are formed, and then a protective film is laminated thereon. Here, FIG. 3A shows the color filter 50 without the protective film in top view.

The color filter substrate 10 which is rectangular-shaped and provided with the color filter 50 is cut out from a mother substrate 1 having a large area shown in FIG. 3B, for example. In greater detail, a pattern corresponding to one color filter 50 is formed on each surface of a plurality of color filter forming areas 11 set on the mother substrate 1, and grooves for being cut are formed on the periphery of the color filter forming areas 11. Further, the mother substrate 1 is cut along the grooves. Accordingly, the color filter substrate 10 which is rectangular-shaped and provided with the color filter 50 is provided.

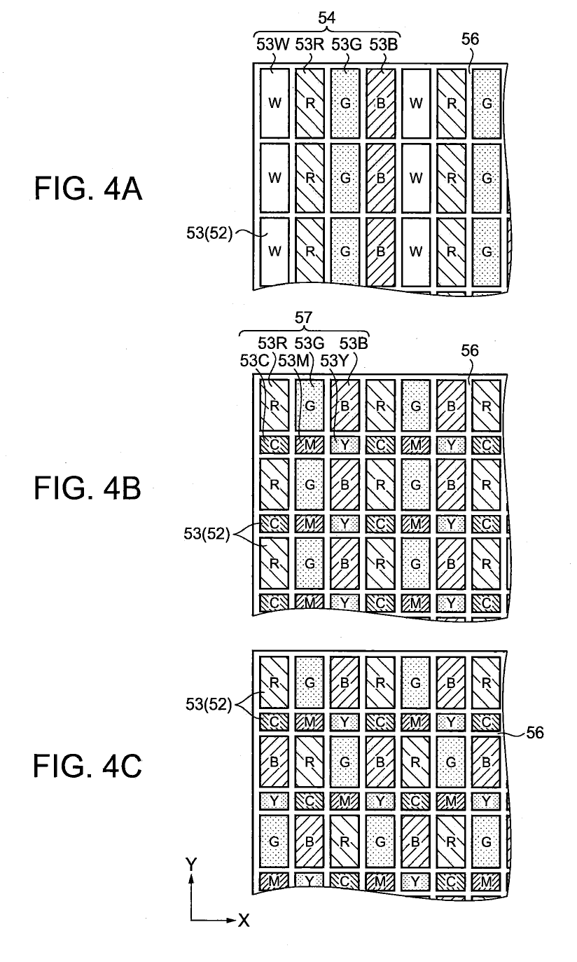

An arrangement of the color elements will be next described. The color elements 53 are formed by filling a plurality of the color element areas 52, which are for example rectangular-shaped, with color material. The color element areas 52 are blocked out by a partition 56 formed in lattice-like pattern by non-translucent resin material, and arranged in dot matrix. FIGS. 4A to 4C are plane views showing arrangement examples of the color element. FIG. 4A illustrates an arrangement of a four-color filter, and FIGS. 4B and 4C illustrate arrangements of a six-color filter. Examples of an arrangement which is known include; a stripe arrangement, a mosaic arrangement, a delta arrangement, and the like. The stripe arrangement arranges color elements 53 in a manner that all of the color elements 53 in one longitudinal column of matrix has a same color. The mosaic arrangement arranges color elements 53 in adjacent lateral columns so as to slip in the lateral direction by one color element 53. In a case of a three-color filter, any three color elements 53 adjacent each other on a longitudinal column or a lateral column have different colors, i.e. three colors. The delta arrangement arranges color elements 53 in adjacent columns on different levels. In a case of a three-color filter, any three color elements 53 adjacent each other have different colors.

In a four-color filter shown in FIG. 4A, each color element 53 is made of color material of one of red (R), green (G), blue (B), or water-clear (W). A combination including each one of color elements 53R, 53G, 53B, 53W of R, G, B, W adjacent each other forms a filter of a picture element (hereinafter, referred to as “picture element filter”) which is the minimum unit constituting a pixel. Light is selectively allowed to pass through any one of the color elements 53R, 53G, 53B, 53W or their combination in one picture element filter so as to realize a full-color display. At this time, the partition 56 made of non-translucent resin material works as a black matrix. In the four-color filter of FIG. 4A, the picture element filters 54 are arranged in a stripe fashion.

In a six-color filter shown in FIG. 4B, each color element 53 is made of a color material of one of red (R), green (G), blue (B), cyan or blue green (C), magenta or purplish red (M), or yellow (Y). A combination including each one of color elements 53R, 53G, 53B, 53C, 53M, 53Y of R, G, B, C, M, Y adjacent each other forms a picture element filter 57 corresponding to one picture element. R, G, B which are light's three primary colors are arranged in a row in lateral direction (x direction in FIGS. 4A to 4C), and C, M, Y which are complementary colors of R, G, B are arranged in an adjacent manner to R, G, B respectively. Light is selectively allowed to pass through any one of the color elements 53R, 53G, 53B, 53C, 53M, 53Y or their combination in one picture element filter so as to realize a full-color display. In the six-color filter of FIG. 4B, the picture element filters 57 are arranged in a stripe fashion. In the six-color filter of FIG. 4C, the picture element filters 57 are arranged in a mosaic fashion.

In the six-color filter of FIG. 4B or FIG. 4C, areas of color elements 53C, 53M, 53Y of C, X, Y which are complementary colors of R, G, B which are light's three primary colors are smaller than the ones of color elements 53R, 53G, 53B of R, G, B. Even though the same light source is used, the brightness of output light is different depending on the color element 53. The difference of area compensates the difference of brightness. A size of one color element 53 is for example 30 μm><100 μm or 30 μm×60 μm, and 30 μm×20 μm. In addition, a gap between color elements 53, i.e. a pitch between elements is for example 45 μm.

Next, a droplet discharge method to be used for forming a color filter such as the above color filter 50 and the like will be described. Examples of droplet discharge techniques of a droplet discharge method may include charge control, pressurized vibration, electromechanical conversion, electrothermal conversion, and electrostatic suction. The charge control is a method to apply electric charges to a material with a charged electrode so as to discharge the material from a discharge nozzle while controlling its flying direction with a deflection electrode. The pressurized vibration is a method to discharge at a discharge a material nozzle tip by applying an extra-high voltage of approximately 30 kg/cm² to a material. If no control voltage is applied, the material goes straight ahead so as to be discharged from the discharge nozzle. If a control voltage is applied, the electrostatic repulsion within the material causes the dispersion of the material, thereby discharging no material from the discharge nozzle. The electromechanical conversion is a method that uses the deformation characteristic of piezoelectric elements in response to a pulsed electric signal. The method applies pressure to a space storing a material with an elastic material therebetween by deforming a piezoelectric element and pushes the material out of the space to discharge it from a discharge nozzle.

The electrothermal conversion is a method to produce bubbles by rapidly evaporating a material with a heater provided in a space storing the material so as to discharge the material out of the space by the pressure of bubbles. The electrostatic attraction is a method that applies micro pressure to a space storing a material so as to form a meniscus of the material at a discharge nozzle. Electrostatic attraction is then applied to pull out the material. Other than the methods, a method that uses a fluid viscosity change caused by an electric field, and a method that uses electric discharge sparks can also be employed. The droplet discharge method has an advantage of adequately disposing a material in a desired amount to a desired location with little waste of the material. Among these, the piezo method has an advantage of giving no influence to the composition and the like of the material because no heat is applied to the liquid material. The above piezo method is used in the embodiment due to a high freedom degree in selecting a liquid material and a good controllability of droplets.

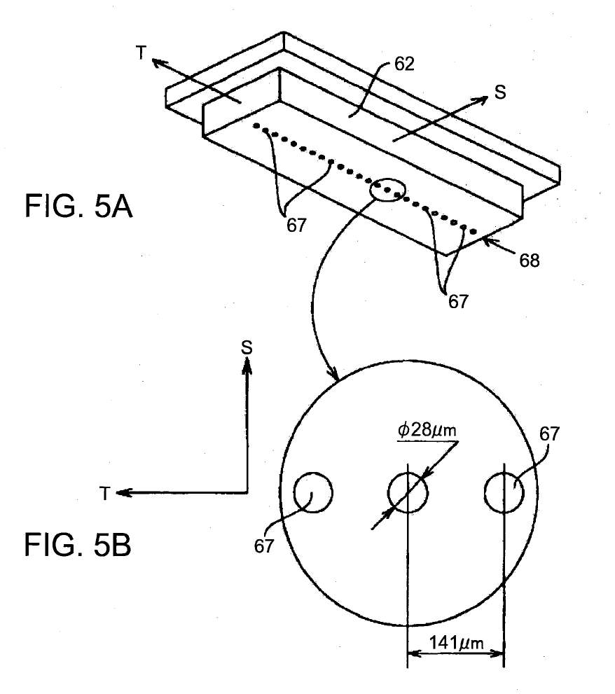

A droplet discharge head of a device manufacturing apparatus used for manufacturing a device according to the embodiment of the present invention by the droplet discharge method will now be described. This device manufacturing apparatus is a droplet discharge apparatus (inkjet apparatus) discharging droplets from a droplet discharge head thereof to a substrate so as to manufacture a device. FIGS. 5A and 5B are schematic views showing an outline of a droplet discharge head. FIG. 5A is a perspective view showing an outline of a droplet discharge head, and FIG. 5B is a schematic view showing an arrangement of nozzles As shown in FIG. 5A, a droplet discharge head 62 includes a nozzle row 68 composed of for example, an arrangement of a plurality of discharge nozzles 67. A number of the discharge nozzles 67 is for example 180, a diameter thereof is for example 28 μm, and a pitch therebetween is for example 141 μm (refer to FIG. 5B). In FIG. 5A, a based direction S denotes a main scanning direction of the droplet discharge head 62 in transferring relatively to the substrate so as to land droplets on arbitrary positions of the substrate. An arrangement direction T denotes a direction in which the discharge nozzles 67 are arranged in the nozzle row 68.

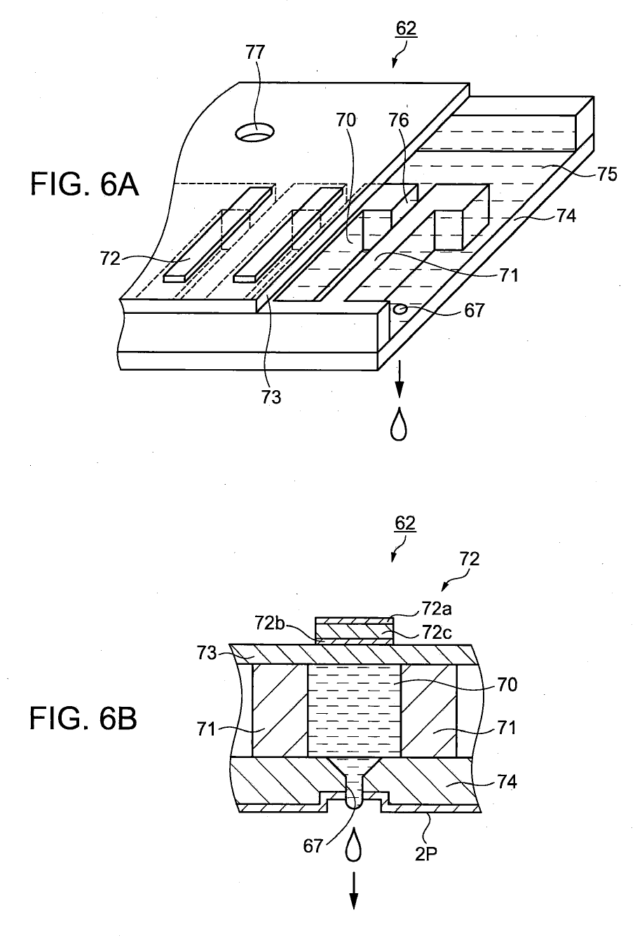

FIG. 6A is a perspective view showing a structure of a droplet discharge head, and FIG. 6B is a sectional view showing a detailed structure of a discharge nozzle part of the droplet discharge head. As shown in FIGS. 6A and 6B, each of the discharge head 62 is provided with a diaphragm 73 and a nozzle plate 74. A reservoir 75 is provided between the diaphragm 73 and the nozzle plate 74. The reservoir 75 is constantly filled with liquid material supplied from a liquid material tank (not shown) through an opening 77. Also provided between the diaphragm 73 and the nozzle plate 74 is a plurality of head partitions 71. A space formed by the diaphragm 73, the nozzle plate 74 and a pair of the partitions 71 is a cavity 70. Provided correspondingly to the discharge nozzles 67, the cavities 70 are provided in the same number as the discharge nozzles 67. Into the cavity 70, liquid material is supplied from the reservoir 75 through a supply opening 76 positioned between a pair of partitions 71.

On the diaphragm 73, a vibrator 72 is provided corresponding to each cavity 70. The vibrator 72 is composed of a piezo element 72c, and a pair of electrodes 72a, 72b sandwiching the piezo element 72c. By applying a driving voltage to the pair of electrodes 72a, 72b, liquid material is discharged as droplets from the discharge nozzle 67 corresponding to them. In order to prevent a part of liquid material discharged form the discharge nozzle 67 from adhering to the nozzle plate 74, a liquid repellency processed layer 2P which has a liquid repellency property to a liquid material is formed on an exterior surface of the nozzle plate 74.

A controlling apparatus (not shown) controls voltage applied to the piezo element 72c, that is, a driving signal so as to control a discharge of the liquid material of each of the discharge nozzles 67. More specifically, the controlling apparatus can change a volume of droplets discharged from the discharge nozzle 67, a number of droplets discharged per unit time, a distance between droplets landed on the substrate. If discharge nozzles 67 discharging droplets are used selectively from the discharge nozzles 67 aligning in the nozzle row 68 for example, a plurality of droplets can be discharged at a time by a pitch of the discharge nozzles 67 in a range of the length of the nozzle row 68. In the based direction S, a distance between droplets landed on the substrate can be individually changed in each discharge nozzle 67 discharging the droplets. In addition, the volume of the droplets discharged from each of the discharge nozzles 67 is variable within a range from 1 pl (picoliters) to 300 pl.

### Method for Manufacturing Color Filter Substrate

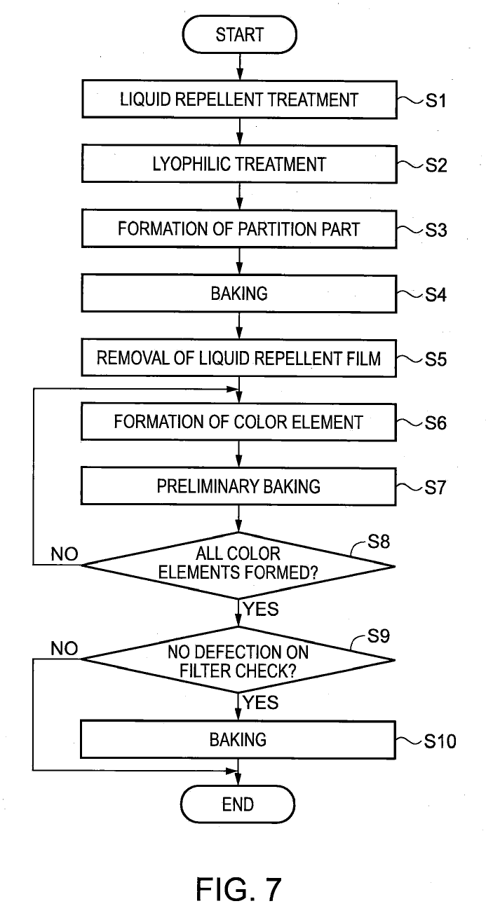

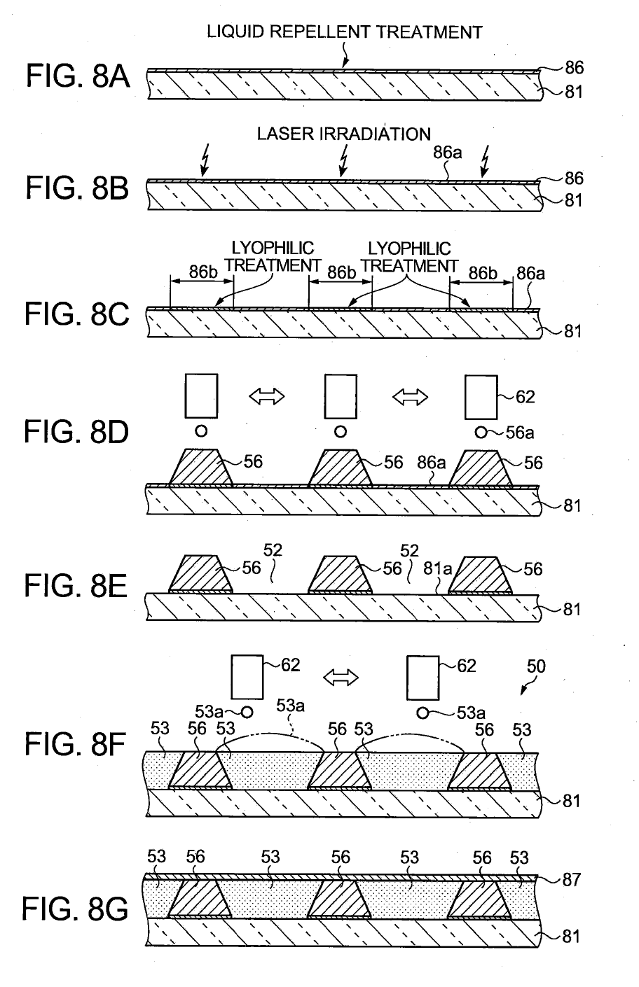

A process of manufacturing a color filter substrate will now be described with reference to FIG. 7 and FIGS. 8A to 8G. FIG. 7 is a flow chart showing processes of manufacturing a color filter substrate. FIGS. 8A to 8G are sectional views schematically showing processes of manufacturing a color filter substrate.

As shown in FIG. 7, a method for manufacturing the color filter substrate 10 includes a liquid repellent process (step S1), and a lyophlic process (step S2). In the step S1, a surface of a glass substrate 81 (the mother substrate 1: refer to FIG. 3) is imparted a surface treatment so as to provide a liquid repellence property. In the step S2, a part of a surface of the glass substrate 81 applied a liquid repellent treatment is imparted a surface treatment so as to provide a lyophilic property. The part of the surface corresponds to an area to be provided with the partition 56. The method further includes a process of providing the partition part 56 (step S3) and a process of forming plural kinds of color elements 53 (step S6). In the step S3, the partition part sections to provide a plurality of color element areas 52 on the glass substrate 81. In the step S6, a function liquid including different kinds of color element forming materials is discharged to the plurality of color element areas 52 so as to provide the plural kinds of color elements 53.

The step S1 of FIG. 7 is a process of a liquid repellent treatment. In the step S1, a thin film 86 is formed over the surface of the glass substrate 81 so as to provide a liquid repellency property, as shown in FIG. 8A. As a method for forming the thin film 86, fluoroalkylsilane (FAS) or hexamethyldisilazane (HMDS) as a material having a liquid repellent property is used so as to form the thin film 86 composed of nearly monomolecular film. More specifically, a method for forming a self-assembled film on the glass substrate 81 or the like can be employed.

In the method for forming a self assembled film, a self assembled film composed of an organic molecular film or the like is formed on the surface of the glass substrate 81. The organic molecular film includes a first functional group, a second functional group, and a normal or a partially branched carbon chain. The first functional group can bond with the glass substrate 81. The second functional substrate modifies the properties of the surface (controls the surface energy) as a liquid repellent group on the opposite end. The carbon chain interconnects these functional groups. The organic molecular film bonds with the glass substrate 81 and self-assembles to form a molecular film such as a monomolecular film.

The self-assembled film is composed of a bonding functional group that can react with atoms constituting a foundation layer of the glass substrate 81 and a normal chain molecule other than the bonding functional group. The self-assembled film is formed by aligning a compound having an extremely high alignment due to the interaction of the normal chain molecules. Since the self-assembled film is provided by aligning monomolecules, the film can be deposited extremely thinly and evenly at the molecular level. In other words, since identical molecules are disposed over the film surface, the film surface can be provided with an even and excellent liquid repellent property.

If fluoroalkylsilane is used, for example, as a compound having high alignment as mentioned above, each compound is aligned to form a self-assembled film in a manner positioning the fluoroalkyl group over the film surface. Accordingly the film surface is provided with the even liquid repellency property. Examples of the compound forming the self-assembled film include fluoroalkylsilane (hereafter, referred to as “FAS”) such as heptadecafluoro-1,1,2,2-tetrahydrodecyl-triethoxysilane, heptadecafluoro-1,1,2,2-tetrahydrodecyl-trimethoxysilane, heptadecafluoro-1,1,2,2-tetrahydrodecyl-trichlorosilane, tridecafluoro-1,1,2,2-tetrahydrooctyl-triethoxysilane, tridecafluoro-1,1,2,2-tetrahydrooctyl-trimethoxysilane, tridecafluoro-1,1,2,2-tetrahydrooctyl-trichlorosilane, trifluoropropyl trimethoxysilane, and the like. These compounds can be used singly or in combination. The use of FAS can provide adhesiveness with the glass substrate 81 and good liquid repellent property.

FAS is commonly expressed by a structural formula: RnSiX(4−n). In the formula, n indicates an integer number from 1 to 3 inclusive, X indicates hydrolytic groups such as a methoxy group, an ethoxy group, a halogen atom, and the like. Further, R indicates a fluoroalkyl group having the following structure: (CF₃)(CF₂)x(CH₂)y where x indicates an integer number from 0 to 10 inclusive, and y indicates an integer number from 0 to 4 inclusive. If a plurality of Rs or Xs are bonded with Si, the Rs or the Xs can be same or different from each other. The hydrolytic group indicated by X forms silanol by hydrolysis to react with a hydroxyl group of the glass substrate 81 which is the fundamental layer of FAS, thereby bonding with the glass substrate 81 by siloxane bond. On the other hand, the R includes fluoro groups such as (CF2) and the like on the surface thereof, thereby modifying the properties of the surface of the glass substrate 81 hard to get wet (a surface energy is low).

A self-assembled film composed of an organic molecular film and the like is formed over the glass substrate 81 by putting the above material compound and the glass substrate 81 in an airtight container and leaving it at room temperature for a couple of days. Further, if the whole of the container is kept at 100 degrees centigrade, the film can be formed over the glass substrate 81 in about three hours. Formed from the vapor phase in these methods, a self-assembled film can also be formed from the liquid phase. For example, the glass substrate 81 is immersed in a solution containing a raw material compound, is cleaned, and is dried, providing a self-assembled film over the glass substrate 81. It is preferable that, before forming a self-assembled film, pre-treatment such as irradiating with ultraviolet light, washing with a solvent, and the like be implemented to the surface of the glass substrate 81.

The step S2 of FIG. 7 is a process of a lyophilic treatment, In the step S2, a surface 86a implemented a liquid repellent treatment is irradiated with laser light so as to give a lyophilic property, as shown in FIG. 8B. In a part irradiated with laser light, FAS is resolved, providing a lyophilic property. Here, a range irradiated with laser light is an area 86b to be provided with the partition 56, as shown in FIG. 8C.

Laser light to be irradiated preferably has a wavelength range by which beat is generated, and preferably has a wavelength range provided in an infrared region (0.7 to 10 μm), for example. Examples of such a laser light source to be used may include Nd:YAG laser (1.064 μm), CO2 laser (10.6 μm), and the like. With the use of a laser irradiating apparatus provided with the above laser light source and a table which is movable in at least X and Y directions, the glass substrate 81 is placed on the table and irradiated with laser light like drawing the area 86b so as to carry out a lyophilic treatment.

A method for applying a lyophilic treatment to the thin film 86 made of FAS and the like can employ a method in which an area other than the area 86b to be applied a lyophilic treatment is covered with a mask, and irradiated with ultraviolet light (UV).

The step S3 of FIG. 7 is a process of forming a partition part. In the step S3, the partition 56 is formed by using the droplet discharge head 62 (refer to FIGS. 5A to 6B) mentioned above, as shown in FIG. 8D. As mentioned above, the droplet discharge head 62 can discharge liquid material in droplets from the nozzle thereof, and therefore it forms the partition 56 by discharging a function liquid 56a including a partition forming material in liquid form.

In particular, the droplet discharge head 62 is positioned in sequence so as to face the area 86b to be provided with the partition 56. The droplet discharge head 62 discharges the function liquid 56a so as to land and spread it. Then the functional liquid 56a is dried. These processes are repeated so as to pile up the function liquid 56a, providing the partition 56. In this case, the height of the partition 56 is approximately 1.5 μm, for example. As the functional liquid 56a, can be used a solution including a phenol based resin and the like as partition forming material.

Next, in the step S4, the partition 56 which is formed is baked. The step S5 performs a process removing the thin film 86 remaining on the glass substrate 81 provided with the partition 56, as shown in FIG. 8E. The thin film 86 is a monomolecular layer made of FAS and the like, and can be sublimed to be removed by heating the glass substrate 81 up to approximately 300 degrees centigrade. In addition, a surface 81a of the glass substrate 81 can be applied a lyophilic treatment, as well, after the thin film 86 is removed. A method for removing the thin film 86 other than heating can employ UV irradiating, O2 plasma treatment, and the like. If the whole of the glass substrate 81 is heated, the steps S4 and S5 can be carried out at a time.

The step S6 in FIG. 7 is a process of forming a color element. In the step S6, as shown in FIG. 8F, the functional liquid 53a including a color element forming material is discharged in droplets from the droplet discharge head 62 to each of the plurality of color element areas 52 formed by the partitions 56 so as to form a color element 53. In this case, the number of discharging times of the functional liquid 53a is adjusted in each color element area so as to render the height of the color element 53 after drying approximately same as the one of the partition 56 (approximately 1.5 μm). Of course, the functional liquids 53a including color element materials different each other are individually discharged to the color element areas 52 to be provided with the color elements 53 of different colors each other. For example, in a case of the six-color filter mentioned above (refer to FIGS. 4B and 4C), six kinds of functional liquids 53a are sequentially filled with the droplet discharge head 62 and discharged. The functional liquids 53a include color element materials different each other due to a correspondence to the color element areas 52 to be provided with the color elements 53R, 53G, 53B, 53C, 53M, 53Y of different colors. Alternatively, a plurality of the droplet discharge heads 62 may be prepared and individually filled with the functional liquids 53a including different color elements.

In the step S7, the functional liquid 53a discharged and disposed to the color element area 52 is dried or pre-baked in low temperature (for example, 60 degrees centigrade) so as to being preliminarily solidified or preliminarily hardened.

The step S8 judges if discharging and preliminary baking of the functional liquid 53a are completed or not. In a case where discharging and preliminary baking of the color elements of all colors are not completed (“NO” in the step S8), the process starts from the step S6 again. The functional liquid 53a is discharged to the color element area 52 (the step S6), and the function liquid 53a disposed on the color element area 52 is pre-baked (the step S7) again. In a case where discharging and preliminary baking of the functional liquid 53a are completed (“YES” in the step S8), the process goes on to the step S9. Discharging of the functional liquid 53a to the color element area 52 (the step S6) and preliminary baking of the functional liquid 53 disposed in the color element area 52 (the step S7) may be carried out sequentially in each color, or discharging (the step S6) at once in all colors and then preliminary baking (the step S7) at once in all colors may be carried out.

In the step S9, the color filter substrate 10 formed as the above is checked out to be judged if it has any defects or not. In this check, for example, the partition 56 and the color element 53 described above are scrutinized by the naked eye, a microscope or the like. In this case, the color filter substrate 10 may be taken an image so as to be checked automatically on the basis of the taken image. Defects of the color element 53 include the following cases: a case where there is an absence of the color element 53 (so-called incomplete dot); a case where the color element 53 is formed, but improper because a quantity (volume) of the functional liquid 53a disposed in the color element area 52 is too little or too much; a case where the color element 53 is formed, but foreign substances such as dust and the like is mixed in or attached; and the like.

If any defects are found in the color element 53 (“NO” in the step S9) in the check, the color filter substrate 10 is moved to the base body reproduction process in other process, and the process of manufacturing the color filter substrate is finished.

If no defects are found in the display material in the check (“YES” in the step S9), the process goes on to the step S10. In the step S10, the color element 53 preliminarily baked is baked to solidify or harden completely. Each of the color elements 53R, 53G, 53B, 53C, 53M, 53Y on the color filter substrate 10 are baked at, for example, 200 degrees centigrade to completely solidify or harden. The temperature of the backing treatment may be appropriately determined depending on a composition of the function liquid 53a and the like. In addition, it may be enough just to dry or age the color element 53 in an atmosphere (in inert gas, dried air, or the like) different from the ordinary without heating up to the high temperature particularly. Lastly, as shown in FIG. 8G, a protection layer 87 is formed on the color element 53, and the process of manufacturing a color filter substrate is finished.

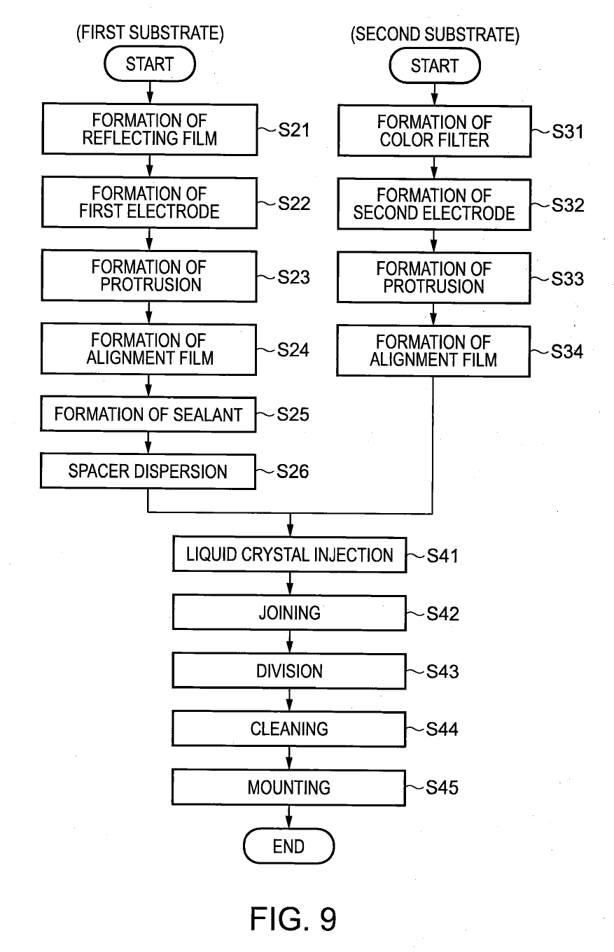

A process of manufacturing a liquid crystal display will be next described. The liquid crystal display 21 described with reference to FIGS. 1 and 2 is manufactured, for example, by carrying out manufacturing processes shown in FIG. 9. FIG. 9 is a flow chart showing processes of manufacturing a liquid crystal display. In the process shown in FIG. 9, the first substrate 27b is formed in a series of processes from the step S21 to the step S26, and the second substrate 27b is formed in a series of processes from the step S31 to the step S34. The process for forming the first substrate and the process for forming the second substrate are usually carried out individually.

A process of forming the first substrate will be first described. In the step S21 of FIG. 9, the reflecting film 32 (refer to FIG. 2) which is as large as a plurality of liquid crystal panels 22 is formed on the surface of a mother material base member made of transparent glass, transparent plastic and the like and having a large area, by photolithography and the like, and further the insulating film 33 (refer to FIG. 2) is formed thereon by a known method of forming a film.

The step S22 forms the first electrode 34a (refer to FIGS. 1 and 2), lead-out wires 34c, 34d, and metal wires 34e, 34f (refer to FIGS. 1 and 2) by using photolithography, droplet discharge mentioned above, and the like.

The step S23 forms a protrusion 82a (refer to FIG. 11) working as an alignment controlling means by using photolithography, droplet discharging mentioned above, and the like.

The step S24 forms the alignment film 36a over the first electrode 34a and the protrusion 82a by coating, printing, and the like. Due to the alignment film 36a, in a state that no voltage is applied to the electrodes, the liquid crystal molecules La of the liquid crystal L are aligned perpendicular to a surface of the alignment film 36a. In other words, the liquid crystal molecules La are aligned perpendicular to the display surface of the liquid crystal display 21 (refer to FIG. 11).

The step S25 forms the sealant 28 in circular fashion by screen printing and the like, for example. The step S26 disperses the spacers 39 which are spherical in an area surrounded by the sealant 28 formed in circular fashion. The above processes form the first mother substrate having a large area which includes several panel patterns of the first substrate 27a of the liquid crystal panel 22.

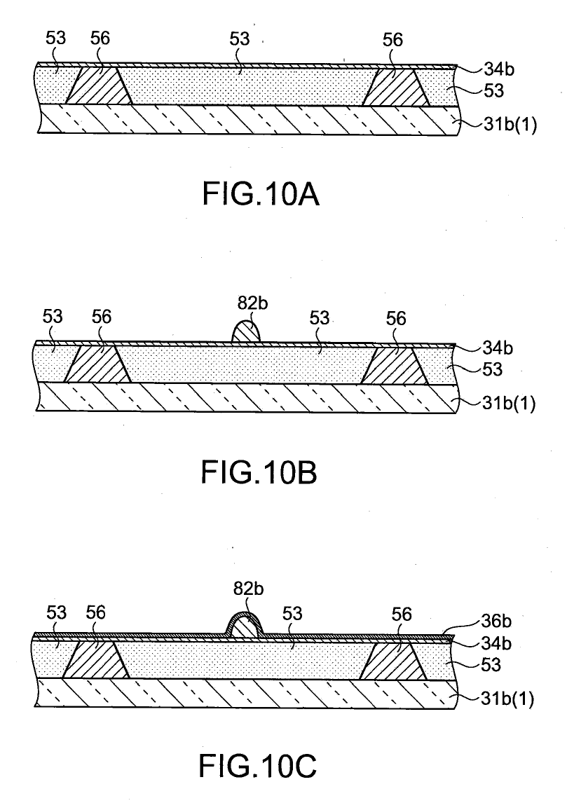

Separate from the above processes of forming the first substrate, processes of forming the second substrate are carries out. FIGS. 10A to 10C are sectional views schematically showing processes of forming the second substrate. The step S31 of FIG. 9 prepares a mother material base member (mother substrate 1: refer to FIG. 3) made of transparent glass, transparent plastic, and the like so as to form the color filter 38 having an area same as several liquid crystal panels 22 on the mother material base member. The process of forming a color filter takes the same process for forming the color filter 10 described with reference to FIGS. 7 to 8G.

Carrying out the step S31 forms the color filter 50, i.e. the color filter 38 on the mother substrate 1, i.e. the mother material base member, as shown in FIG. 8F. The step S32 forms the second electrode 34b as shown in FIG. 10a by photolithography and the like.

The step S33 forms a protrusion 82b (refer to FIG. 11) shown in FIG. 10b and working as an alignment controlling means by using photolithography, droplet discharging mentioned above, and the like.

The step S34 forms an alignment film 36b over the second electrode 34b and the protrusion 82b by coating, printing, and the like, as shown in FIG. 10C. Due to the alignment film 36b, in a state that no voltage is applied to the electrodes, the liquid crystal L is aligned perpendicular to a surface of the alignment film 36b. In other words, the liquid crystal L is aligned perpendicular to the display surface of the liquid crystal display 21. The above processes form the second mother substrate having a large area which includes several panel patterns of the second substrate 27b of the liquid crystal panel 22.

After forming the first mother substrate and the second mother substrate having large areas, the step S41 injects an area surrounded by the sealant 28 formed on the first mother substrate in circular fashion with the liquid crystal L.

The step S42 aligns the first mother substrate and the second mother substrate in a manner interposing the sealant 28 in between so as to join them together. This forms a panel structure body including a panel part as large as several liquid crystal panels. The steps S41 and S42 are carried out in nearly vacuumed state, so that the area surrounded by the sealant 28 and interposed between the first mother substrate and the second mother substrate is filled only with liquid crystal L without an infiltration of air or the like.

The step S43 forms a scribe groove, i.e. a groove for cutting on a predetermined position of the panel structure body which is completed, and further, breaks, i.e. divides the panel structure body on the basis of the scribe groove. This cuts out a plurality of the liquid crystal panels 22 individually. The step S44 cleans each of the liquid crystal panels 22. The step S45, as shown FIG. 1, implements the liquid crystal driving ICs 23a, 23b, implements the illuminator 26 as a back light, and couples the FPC 24 to each of the liquid crystal panels 22. Accordingly, the liquid crystal display 21 which is desired is completed.

Next, regulating an alignment direction depending on the protrusions 82a and 82b will be described. FIG. 11 is a sectional view of a liquid crystal panel showing an alignment direction of liquid crystal when no driving voltage is applied. As mentioned above, the first substrate 27a includes the first electrode 34a, the protrusion 82a, the alignment film 36a on the base member 31a thereof. Here, the reflecting film 32 and the insulating film 33 have no influence to the alignment of liquid crystal, thereby being not shown in FIG. 11. The second substrate 27b has an arrangement on the base member 31b thereof in order of the partition 56 and the color element 53, the second electrode 34b, the protrusion 82b, the alignment film 36b. The first substrate 27a and the second substrate 27b are joined together in a manner that the alignment film 36a and the alignment film 36b face each other while interposing a gap in between. The gap is filled with the liquid crystal L.

In the liquid crystal panel 22 in a state that no driving voltage is applied to the first electrode 34a and the second electrode 34b, the liquid crystal molecules La of the liquid crystal L are aligned perpendicular to the alignment film 36a or the alignment film 36b, as shown in FIG. 11. In other words, the liquid crystal molecules La are aligned perpendicular to the surfaces of the base members 31a and 31b on flat parts of the alignment films 36a and 36b other than parts of the protrusions 82a and 82b. Hereinafter, a direction perpendicular to the surfaces of the base members 31a and 36b is denoted as “panel surface vertical direction”, and a direction parallel to the surfaces of the base members 31a and 31b and perpendicular to the “panel surface vertical direction” is denoted as “panel surface direction”. The liquid crystal molecules La are aligned perpendicular to each surface of the protrusions 82a and 82b. The liquid crystal molecules La aligned perpendicular to the lateral faces or the like of the protrusions 82a and 82b are aligned with inclination to the panel surface vertical direction. The liquid crystal molecules La are aligned in the panel surface vertical direction, thereby preventing light from transmitting the liquid crystal layer.

If predetermined driving voltage is applied between the first electrode 34a and the second electrode 34b, the liquid crystal molecules La incline approximately perpendicular to the direction of the electrical field. The liquid crystal molecules La are aligned approximately to the panel surface direction, thereby transmitting light in the liquid crystal layer. If an applied voltage is low and an intensity of the electrical field is weak, the liquid crystal molecules La are aligned with an angle corresponding to the intensity of the electrical field between the panel surface vertical direction and the panel surface direction. Controlling the alignment angle controls the amount of transmitted light, controlling the brightness of a pixel. Controlling the brightness of each of pixels constituting a picture element provides a color of the picture element.

If predetermined driving voltage is applied to the first electrode 34a and the second electrode 34b, the liquid crystal molecules La, which are aligned with inclination to the panel surface vertical direction by aligning perpendicular to the lateral face and the like of the protrusions 82a or 82b, inclines in the direction in which they originally incline. Other liquid crystal molecules La adjacent to the liquid crystal molecules La aligned with inclination are affected to incline in the same direction. In FIG. 11, all of the liquid crystal molecules La in the area E1 incline to one direction, and all of the liquid crystal molecules La in the area E2 incline to another direction different from the direction to which the liquid crystal molecules La in the area E1 incline. Thus, applying driving voltage forms areas including an area having liquid molecules La inclining in one direction, and another area having the ones inclining in another direction, while rendering the protrusions 82a or 82b a border. Therefore, the color element area 52 which is divided into several areas and alignment-direction controlled by the protrusion 82a or the 82b has different viewing angle dependences, so that the liquid crystal panel 22 has a larger viewing angle property. The protrusion 82a or 82b corresponds to an alignment controlling means.

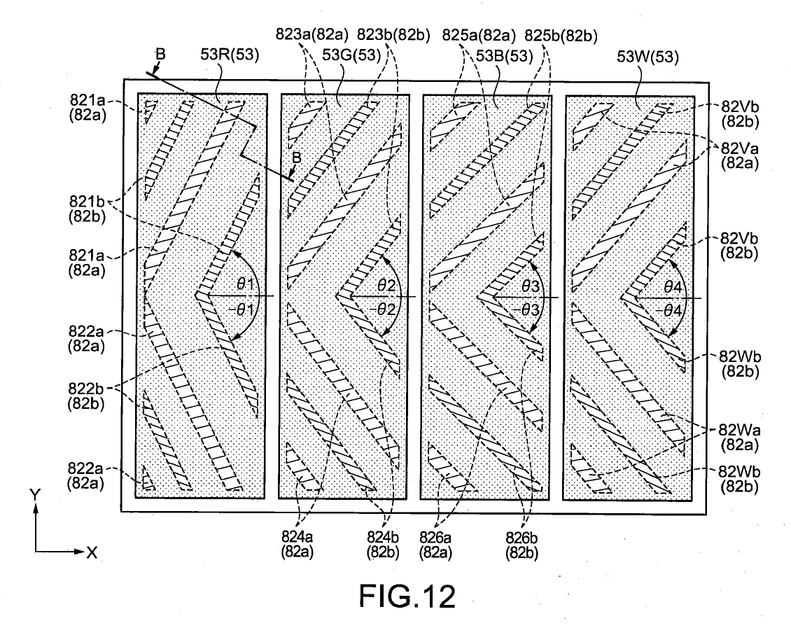

Extending directions of the protrusions 82a and 82b will be next described. FIG. 12 is a plan view showing an extending direction of a protrusion in a picture element of a four-color filter. FIG. 11 mentioned above is a cross-section along the B-B line in FIG. 12.

As shown in FIG. 12, one picture element is composed of pixels respectively including color elements 53R (red), 53G (green), 53B (blue), and 53W. The color elements 53R, 53G, 53B respectively correspond to the color elements 53 of red, green, and blue of the light's three primary colors. The color element 53W corresponds to the color element 53 of water-clear. The protrusion 82a formed in a pixel including the color element 53R has two kinds of protrusions 821a and 822a of which extending directions are different from each other. Respective protrusions 821a and 822a have several kinds of lengths. Here, as shown in FIG. 12, an aligning direction of the color elements 53R, 53G, 53B, 53W which are four kinds of color elements 53 constituting one picture element is denoted X-direction. The protrusion 821a extends in a direction inclining by 1 degree [theta] to the X-direction, and the protrusion 822a extends in a direction inclining by −1 degree [theta] to the X-direction. In the same way, the protrusion 82b formed in a pixel including the color element 53R has two kinds of protrusions 821b and 822b of which extending directions are different from each other. The protrusion 821b extends in a direction inclining by 1 degree [theta] to the X-direction, and the protrusion 822b extends in a direction inclining by −1 degree [theta] to the X-direction. Respective protrusions 821b and 822b have several kinds of lengths. A direction inclining by 1 degree [theta], or a direction inclining by −1 degree [theta] to the X-direction, in which the protrusion 82a or 82b extends, corresponds to a first extending direction or a second extending direction.

Respective protrusions 82a formed in pixels including the color elements 53G, 53B, 53W which correspond to the other color elements 53 constituting one picture element also has two kinds of protrusions 823a and 824a, 825a and 826a, 82Va and 82Wa. The protrusions 82b formed in pixels including the color elements 53G, 53B, 53W also respectively have two kinds of protrusions 823b and 824b, 825b and 826b, 82Vb and 82Wb of which extending directions are different from each other. The protrusions 823a, 824a, 825a, 826a 82Va, and 82Wa extend with inclination respectively by 2 degrees [theta], −2 degrees [theta], 3 degrees [theta], −3 degrees [theta], 4 degrees [theta], and −4 degrees [theta]. Respective protrusions 824a, 825a, 826a, 82Va, 82Wa have several kinds of lengths. The protrusions 823b, 824b, 825b, 826b 82Vb, and 82Wb extend with inclination respectively by 2 degrees [theta], −2 degrees [theta], 3 degrees [theta], −3 degrees [theta], 4 degrees [theta], and −4 degrees [theta]. Respective protrusions 823b, 824b, 825b, 826b 82Vb, 82Wb have several kinds of lengths. In pixels respectively including the color elements 53R, 53G, 53B, 53W constituting one picture element, extending directions of the protrusions 82a and 82b are different from each other depending on the color of the color element 53. A direction inclining by 2 degrees [theta], 3 degrees [theta], or 4 degrees [theta], or a direction inclining by −2 degrees [theta], −3 degrees [theta], −4 degrees [theta] to the X-direction, in which the protrusion 82a or 82b extends, corresponds to the first extending direction or the second extending direction.

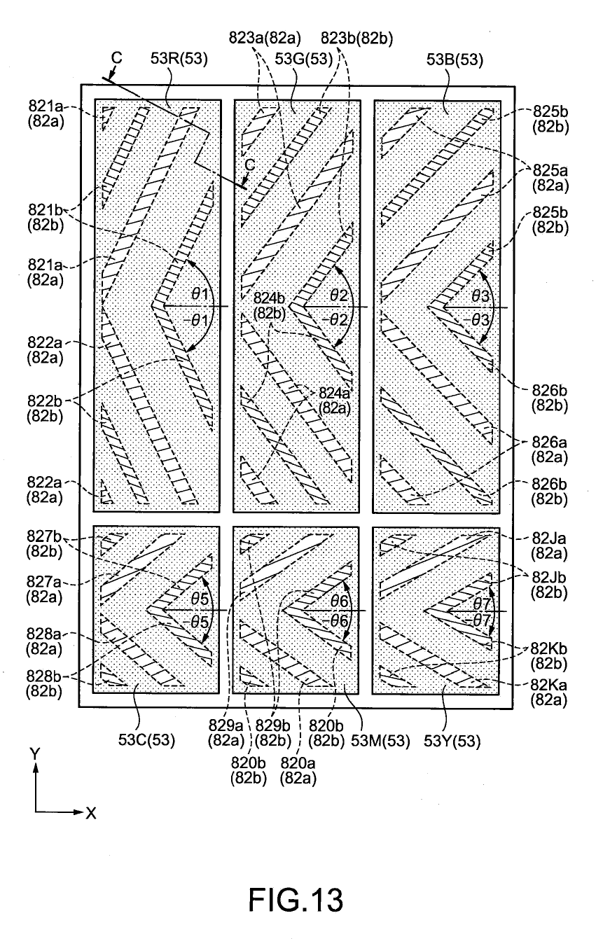

An example of extending directions of the protrusions 82a and 82b of a six-color filter will be next described. FIG. 13 is a plan view showing an extending direction of a protrusion in a picture element of a six-color filter. A sectional shape of a section viewed along the line C-C of FIG. 13 is substantially same as the shape of the above mentioned cross-section shown in FIG. 11.

As shown in FIG. 13, one picture element is composed of pixels respectively including color elements 53R, 53G, 53B, 53C, 53M, and 53Y. The 53R, 53G, 53B correspond to the color elements 53 of the light's three primary colors. The 53c, 53M, 53Y correspond to the color elements 53 of complementary colors of the light's three primary colors. The protrusion 82a formed in a pixel including the color element 53R has two kinds of protrusions 821a and 822a of which extending directions are different from each other. Respective protrusions 821a and 822a have several kinds of lengths. Here, in the same way as the four-color filter of FIG. 12, an aligning direction of the 53R, 53G, 53B, or the 53C, 53M, 53Y which correspond to three of six kinds of color elements 53 constituting one picture element is denoted as X-direction. The protrusion 821a extends in a direction inclining by 1 degree [theta] to the X-direction, and the protrusion 822a extends in a direction inclining by −1 degree [theta] to the X-direction. In the same way, the protrusion 82b formed in a pixel including the color element 53R has two kinds of protrusions 821b and 822b of which extending directions are different from each other. The protrusion 821b extends in a direction inclining by 1 degree [theta] to the X-direction, and the protrusion 822b extends in a direction inclining by −1 degree [theta] to the X-direction. Respective protrusions 821b and 822b have several kinds of lengths

Respective protrusions 82a formed in pixels respectively including the color elements 53G, 53B, 53C, 53M, 53Y which correspond to the other color elements 53 constituting one picture element also has two kinds of protrusions 823a and 824a, 825a and 826a, 827a and 828a, 829a and 820a, 82Ja and 82Ka. Respective protrusions 82b formed in pixels respectively including the color elements 53G, 53B, 53C, 53M, 53Y also has two kinds of protrusions 823b and 824b, 825b and 826b, 827b and 828b, 829b and 820b, 82Jb and 82Kb of which extending directions are different from each other.

The protrusions 823a, 824a, 825a, 826a 827a, 828a, 829a, 820a, 82Ja, and 82Ka extend with inclination respectively by 2 degrees [theta], −2 degrees [theta], 3 degrees [theta], −3 degrees [theta], 5 degrees [theta], −5 degrees [theta], 6 degrees [theta], −6 degrees [theta], 7 degrees [theta], and −7 degrees [theta], and respective protrusions 823a, 824a, 825a, 826a 827a, 828a, 829a, 820a, 82Ja, and 82Ka have several kinds of lengths. The protrusions 823b, 824b, 825b, 826b 827b, 828b, 829b, 820b, 82Jb, and 82Kb extend with inclination respectively by 2 degrees [theta], −2 degrees [theta], 3 degrees [theta], −3 degrees [theta], 5 degrees [theta], −5 degrees [theta], 6 degrees [theta], −6 degrees [theta], 7 degrees [theta], and −7 degrees [theta], and respective protrusions 823b, 824b, 825b, 826b 827b, 828b, 829b, 820b, 82Jb, and 82Kb have several kinds of lengths. In pixels respectively including the color elements 53R, 53G, 53B, 53C, 53M, 53Y constituting one picture element, extending directions of the protrusions 82a and 82b are different from each other depending on the color of the color element 53. A direction inclining by 1 degree [theta], 2 degrees [theta], 3 degrees [theta], 5 degrees [theta], 6 degrees [theta], or 7 degrees [theta], or a direction inclining by −1 degree [theta], −2 degrees [theta], −3 degrees [theta], −5 degrees [theta], −6 degrees [theta], or −7 degrees [theta] to the X-direction, in which the protrusion 82a or 82b extends, corresponds to the first extending direction or the second extending direction.

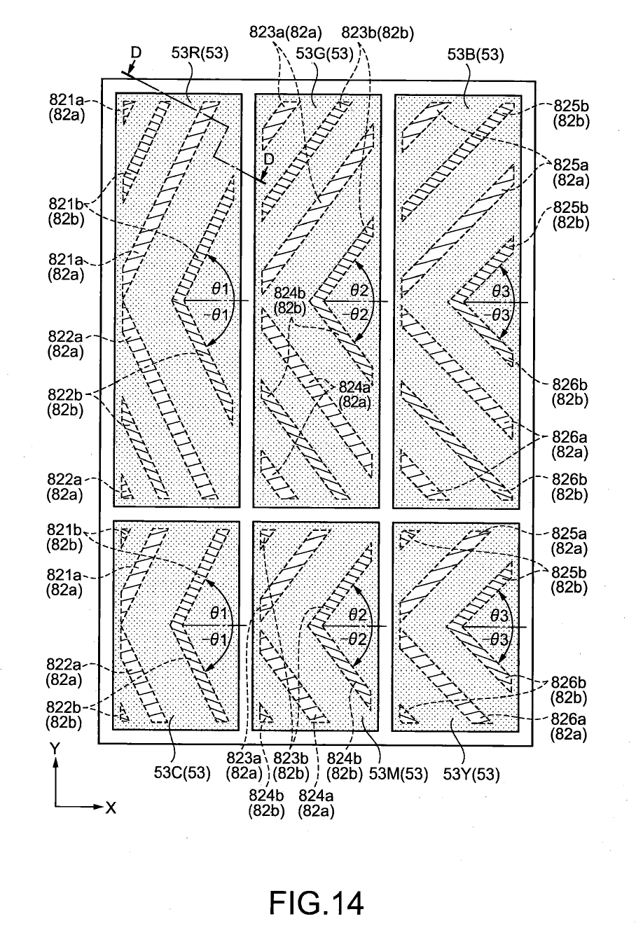

Another example of extending directions of the protrusions 82a and 82b of a six-color filter will be next described. FIG. 14 is a plan view showing an extending direction of a protrusion in a picture element of a six-color filter. A sectional shape of a section viewed along the line D-D of FIG. 14 is substantially same as the shape of the above mentioned cross-section shown in FIG. 11.

As shown in FIG. 14, one picture element is composed of pixels including color elements 53R, 53G, 53B, 53C, 53M, and 53Y. The color elements 53R, 53G, 53B correspond to the color elements 53 of the light's three primary colors. The color elements 53C, 53M, 53Y correspond to the color elements 53 of complementary colors of the light's three primary colors. The protrusion 82a formed in a pixel including the color element 53R or 53C has two kinds of protrusions 821a and 822a of which extending directions are different from each other. Here, in the same way as the four-color filter of FIG. 12, an aligning direction of the color elements 53R, 53G, 53B, or the color elements 53C, 53M, 53Y which correspond to three of six kinds of color elements 53 constituting one picture element is denoted as X-direction. The protrusion 821a extends in a direction inclining by 1 degree [theta] to the X-direction, and the protrusion 822a extends in a direction inclining by −1 degree [theta] to the X-direction. Respective protrusions 821a and 822a have several kinds of lengths. In the same way, the protrusion 82b formed in a pixel including the color element 53R or 53C has two kinds of protrusions 821b and 822b of which extending directions are different from each other. The protrusion 821b extends in a direction inclining by 1 degree [theta] to the X-direction, and the protrusion 822b extends in a direction inclining by −1 degree [theta] to the X-direction. Respective protrusions 821b and 822b have several kinds of lengths.

The protrusion 82a formed in a pixel including the color element 53G or 53M has two kinds of protrusions 823a and 824a of which extending directions are different from each other. The protrusion 823a extends in a direction inclining by 2 degrees [theta] to the X-direction, and the protrusion 824a extends in a direction inclining by −2 degrees [theta] to the X-direction. Respective protrusions 823a and 824a have several kinds of lengths. In the same way, the protrusion 82b formed in a pixel including the color element 53G or 53M has two kinds of protrusions 823b and 824b of which extending directions are different from each other. The protrusion 823b extends in a direction inclining by 2 degrees [theta] to the X-direction, and the protrusion 824b extends in a direction inclining by −2 degrees [theta] to the N-direction. Respective protrusions 823b and 824b have several kinds of lengths.

The protrusion 82a formed in a pixel including the color element 53B or 53Y has two kinds of protrusions 825a and 826a of which extending directions are different from each other. The protrusion 825a extends in a direction inclining by 3 degrees [theta] to the X-direction, and the protrusion 826a extends in a direction inclining by −3 degrees [theta] to the X-direction. Respective protrusions 825a and 826a have several kinds of lengths. In the same way, the protrusion 82b formed in a pixel including the color element 53B or 53Y has two kinds of protrusions 825b and 826b of which extending directions are different from each other. The protrusion 825b extends in a direction inclining by 3 degrees [theta] to the X-direction, and the protrusion 826b extends in a direction inclining by −3 degrees [theta] to the X-direction. Respective protrusions 825b and 826b have several kinds of lengths. A direction inclining by 1 degree [theta], 2 degrees [theta], or 3 degrees [theta], or a direction inclining by 1 degree [theta], −2 degrees [theta], or −3 degrees [theta] to the X-direction, in which the protrusion 82a or 82b extends, corresponds to the first extending direction or the second extending direction.

In pixels respectively including the color elements 53R, 53G, 53B which correspond to the color elements 53 of the three primary colors, extending directions of the protrusions 82a and 82b are different from each other depending on the color of the color element 53. In pixels respectively including the color elements 53C, 53M, 53Y which correspond to the color elements 53 of the complementary colors of the three primary colors, extending directions of the protrusions 82a and 82b are different from each other depending on the color of the color element 53.

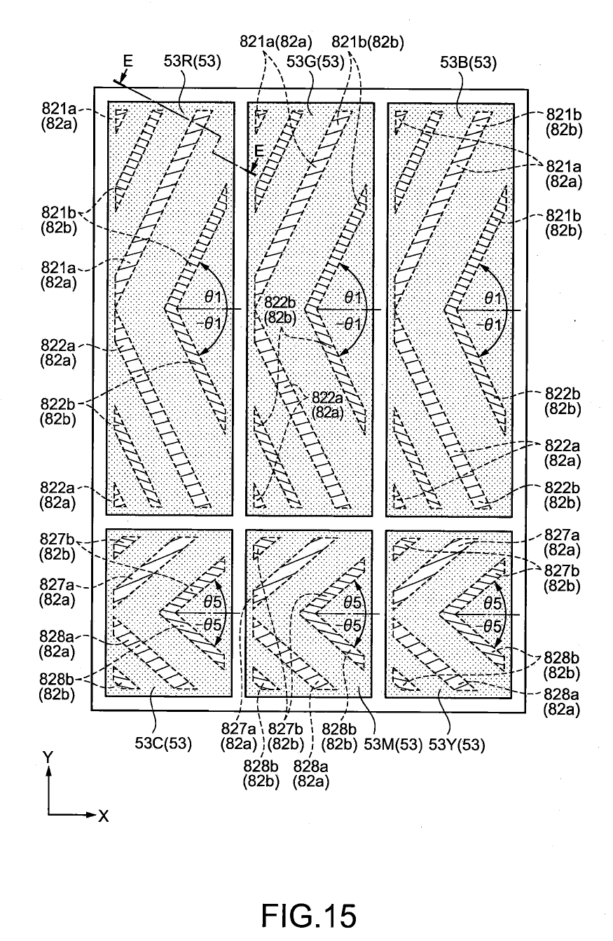

Yet another example of extending directions of the protrusions 82a and 82b of a six-color filter will be next described. FIG. 15 is a plan view showing an extending direction of a protrusion in a picture element of a six-color filter. A sectional shape of a section viewed along the line E-E of FIG. 15 is substantially same as the shape of the above mentioned cross-section shown in FIG. 11.

As shown in FIG. 15, one picture element is composed of pixels respectively including color elements 53R, 53G, 53B, 53C, 53M, and 53Y. The color elements 53R, 53G, 53B correspond to the color elements 53 of the light's three primary colors. The color elements 53C, 53M, 53Y correspond to the color elements 53 of complementary colors of the light's three primary colors. The protrusion 82a formed in a pixel including the color element 53R, 53G, or 53B of the light's three primary colors has two kinds of protrusions 821a and 822a of which extending directions are different from each other. Here, in the same way as the four-color filter of FIG. 12, an aligning direction of the color elements 53R, 53G, 53B, or the color elements 53C, 53M, 53Y which correspond to three of six kinds of color elements 53 constituting one picture element is denoted as X-direction. The protrusion 821a extends in a direction inclining by 1 degree [theta] to the X-direction, and the protrusion 822a extends in a direction inclining by −1 degree [theta] to the N-direction. Respective protrusions 821a and 822a have several kinds of lengths. In the same way, the protrusion 82b formed in a pixel including the color element 53R, 53G, or 53B has two kinds of protrusions 821b and 822b of which extending directions are different from each other. The protrusion 821b extends in a direction inclining by 1 degree [theta] to the X-direction, and the protrusion 822b extends in a direction inclining by −1 degree [theta] to the X-direction. Respective protrusions 821b and 822b have several kinds of lengths.

The protrusion 82a formed in a pixel including the color element 53C, 53M, or 53Y of the complementary colors of the light's three primary colors has two kinds of protrusions 827a and 828a of which extending directions are different from each other. The protrusion 827a extends in a direction inclining by 5 degrees [theta] to the X-direction, and the protrusion 828a extends in a direction inclining by −5 degrees [theta] to the X-direction. Respective protrusions 827a and 828a have several kinds of lengths. In the same ways the protrusion 82b formed in a pixel including the color element 53C, 53M, or 53Y has two kinds of protrusions 827b and 828b of which extending directions are different from each other. The protrusion 827b extends in a direction inclining by 5 degrees [theta] to the X-direction, and the protrusion 828b extends in a direction inclining by −5 degrees [theta] to the X-direction. Respective protrusions 827b and 828b have several kinds of lengths. A direction inclining by 1 degree [theta] or 5 degrees [theta] or a direction inclining by −1 degree [theta] or −5 degrees [theta] to the X-direction, in which the protrusion 82a or 82b extends, corresponds to a first extending direction or a second extending direction.

Extending directions of 82a and 82b in the pixel including the color element 53R are different from the ones in the pixel including the color element 53C which corresponds to the color element 53 of a complementary color of the color element 53R. Extending directions of 82a and 82b in the pixel including the color element 53G are different from the ones in the pixel including the color element 53M which corresponds to the color element 53 of a complementary color of the color element 53G. Extending directions of 82a and 82b in the pixel including the color element 53B are different from the ones in the pixel including the color element 53Y which corresponds to the color element 53 of a complementary color of the color element 53B.

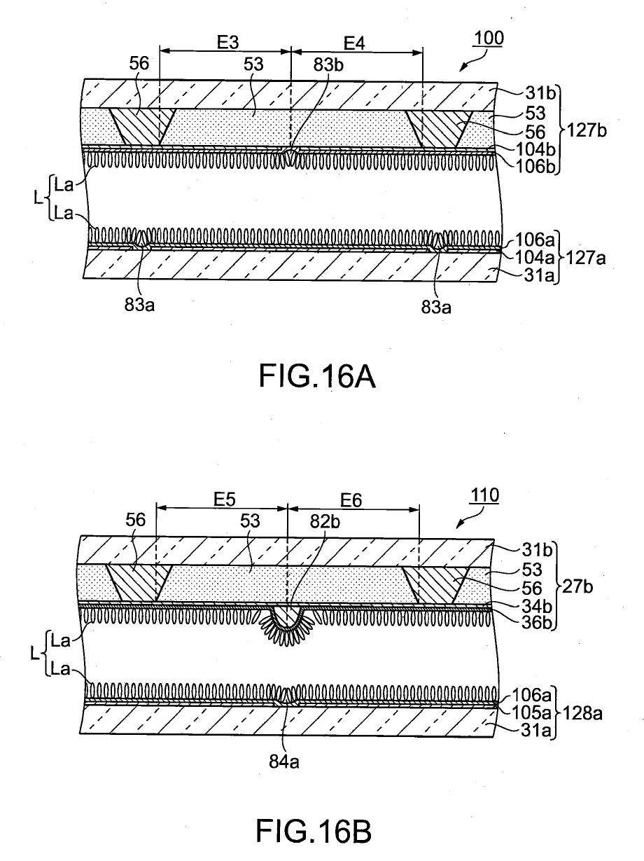

An alignment controlling means in groove shape will be next described as an example of another formation of an alignment controlling means. FIG. 16 is a sectional view showing an alignment direction of liquid crystal in a liquid crystal panel provided with a concave part on a face contacting a liquid crystal layer in a state that no driving voltage is applied. FIG. 16A is a sectional view showing an alignment direction of liquid crystal in a liquid crystal panel provided with a concave part on faces of a first substrate and a second substrate contacting a liquid crystal layer in a state that no driving voltage is applied. FIG. 16B is a sectional view showing an alignment direction of liquid crystal in a liquid crystal panel provided with a protrusion on a second substrate contacting the liquid crystal layer and a concave part on a first substrate contacting a liquid crystal layer in a state that no driving voltage is applied.

A first substrate 127a of a liquid crystal panel 100 shown in FIG. 16A includes a first electrode 104a and an alignment film 106a in order on the base member 31a thereof like the first substrate 27a mentioned above. The first electrode 104a has a slit and a part of the alignment film 106a formed on the slit sinks in, providing a concave part 83a. The reflecting film 32 and the insulating film 33 have no influence to the alignment of liquid crystal, thereby being not shown in FIGS. 16A and 161B. The second substrate 127b has an arrangement on the base member 31b thereof in the order of the partition 56 and the color element 53, a second electrode 104b, an alignment film 106b. The second electrode 104b has a slit and a part of the alignment film 106b formed on the slit sinks in, providing a concave part 83b. The first substrate 127a and the second substrate 127b are joined together in a manner that the alignment film 106a and the alignment film 106b face each other while interposing a gap in between. The gap is filled with the liquid crystal L.

In the liquid crystal panel 100 in a state that no driving voltage is applied to the first electrode 104a and the second electrode 104b, the liquid crystal molecules La of the liquid crystal L align perpendicular to the alignment film 106a or the alignment film 106b, as mentioned above. On a part of the concave part 83a or the concave part 83b, the liquid crystal molecules La align perpendicular to a surface of each concave part. The liquid crystal molecules La aligning perpendicular to the lateral faces or the like of the concave part 83a or 83b align with inclination to the panel surface vertical direction. If the liquid crystal molecules La align in the panel surface vertical direction, the liquid crystal layer allows no light to transmit.

If predetermined driving voltage is applied to the first electrode 104a and the second electrode 104b, the liquid crystal molecules La incline approximately perpendicular to the direction of the electrical field. The liquid crystal molecules La align approximately in the panel surface direction, thereby allowing light to transmit through the liquid crystal layer. If an applied voltage is low and an intensity of the electrical field is weak, the liquid crystal molecules La align with an angle corresponding to the intensity of the electrical field between the panel surface vertical direction and the panel surface direction. Controlling the alignment angle controls the amount of light to transmit, thereby controlling the brightness of a pixel. Controlling the brightness of respective pixels constituting a picture element provides a color of the picture element.

If predetermined driving voltage is applied to the first electrode 104a and the second electrode 104b, the liquid crystal molecules La, which align perpendicular to the lateral face and the like of the concave part 83a or 83b, i.e. align with inclination in the panel surface vertical direction, incline in the direction in which they originally incline. Other liquid crystal molecules La adjacent to the liquid crystal molecules La which have aligned with inclination on the concave part 83a or 83b are affected to incline in the same direction. In FIG. 16A, all of the liquid crystal molecules La in the area E3 incline to one direction, and all of the liquid crystal molecules La in the area E4 incline to another direction different from the direction to which the liquid crystal molecules La in the area E3 incline. Thus, applying driving voltage forms areas respectively including liquid crystal molecules La inclining respective directions different from each other, while rendering the concave part 83a or 83b a border. Therefore, the color element area 52 which is divided into several areas and alignment-direction controlled by the concave part 83a or 83b has several viewing angle dependences, so that the liquid crystal panel 100 is provided with a larger viewing angle property. The concave part 83a or 83b corresponds to the alignment controlling means.

Extending directions of the concave parts 83a and 83b in the panel surface direction and positions where the concave parts 83a and 83b are formed are same as the ones of the protrusions 82a and 82b described in FIGS. 12 to 15.

A first substrate 128a of a liquid crystal panel 110 shown in FIG. 16B includes a first electrode 105a and an alignment film 106a in order on the base member 31a thereof, like the first substrate 127a mentioned above. The first electrode 10a has a slit and a part of the alignment film 106a formed on the slit sinks in, providing a concave part 84a. A second substrate of the liquid crystal panel 110 is the second substrate 27b mentioned above, and has an arrangement on the base member 31b thereof in order of the partition 56 and the color element 53, the second electrode 34b, the protrusion 82b, the alignment film 36b. The first substrate 128a and the second substrate 27b are joined together in a manner that the alignment film 106a and the alignment film 36b face each other while interposing a gap in between. The gap is filled with the liquid crystal L. The concave part 84a and the protrusion 82b extend in the panel surface direction, and their extending directions are approximately same. The convex part 84a and the protrusion 82b almost overlap each other in the panel surface vertical direction.

In the liquid crystal panel 110 in a state that no driving voltage is applied to the first electrode 100a and the second electrode 34b, the liquid crystal molecules La of the liquid crystal L align perpendicular to the alignment film 106a or the alignment film 36b, as mentioned above. On a part of the concave part 84a or the protrusion 82b, the liquid crystal molecules La align perpendicular to a surface of the concave part or the protrusion. The liquid crystal molecules La aligning perpendicular to the lateral faces or the like of the concave part 84a or the protrusion 82b align with inclination to the panel surface vertical direction. Since the convex part 84a and the protrusion 82b face while nearly overlapping each other in the panel surface vertical direction, the direction to which the liquid crystal molecules La incline by the effect of the concave part 84a is same as the direction to which the liquid crystal molecules La incline by the effect of the protrusion 82b, as shown in FIG. 16b.

If predetermined driving voltage is applied to the first electrode 10a and the second electrode 34b, the liquid crystal molecules La incline approximately perpendicular to the direction of the electrical field. If the liquid crystal molecules La align approximately in the panel surface direction, the liquid crystal layer allows light to transmit. If an applied voltage is low and an intensity of the electrical field is weak, the liquid crystal molecules La align with an angle corresponding to the intensity of the electrical field between the panel surface vertical direction and the panel surface direction. Controlling the alignment angle controls the amount of light to transmit, thereby controlling the brightness of a pixel. Controlling the brightness of respective pixels constituting a picture element provides a color of the picture element.

If predetermined driving voltage is applied to the first electrode 105a and the second electrode 34b, the liquid crystal molecules La, which align perpendicular to the lateral face and the like of the concave part 84a or the protrusion 82b, i.e. align with inclination to the panel surface vertical direction, incline in the direction in which they originally incline. Other liquid crystal molecules La adjacent to the liquid crystal molecules La which have aligned with inclination in the concave part 84a or the protrusion 82b are affected to incline in the same direction. In FIG. 16B, all of the liquid crystal molecules La in the area E5 incline in one direction, and all of the liquid crystal molecules La in the area E6 incline in another direction different from the direction in which the liquid crystal molecules La in the E5 incline. Thus, applying driving voltage forms areas respectively including the liquid crystal molecules La inclining in respective directions different from each other, while rendering the concave part 84a and the protrusion 82b a border. Therefore, the color element area 52 which is divided into several areas and alignment-direction controlled by the concave part 84a and the protrusion 82b has several viewing angle dependences, so that the liquid crystal panel 10 has a larger viewing angle property. When driving voltage is applied, the liquid crystal molecules La in one area incline in a direction opposite to the direction in which the liquid crystal molecules La in another area incline while rendering the concave part 84a and the protrusion 82b a border. This provides bifurcation points at which the inclination direction of the liquid crystal molecules La turns to the opposite, at the middle position between the concave parts 84a, and between the protrusions 82b adjusting each other. In FIG. 16b, a bifurcation point is provided to a position near the center of the partition 56. The concave part 84a or the protrusion 82b corresponds to the alignment controlling means.

In the liquid crystal panel 110, an extending direction of the protrusion 82b in the panel surface direction and a position where the protrusion 82b is formed are same as the ones of the protrusion 82b described with reference to FIGS. 12 to 15. An extending direction of the concave part 84a in the panel surface direction and a position where the concave part 84a is formed nearly overlap with the ones of the protrusion 82b as described with reference to FIGS. 12 to 15.

Now, advantageous effects of the first embodiment will be described below. In the picture element shown in FIG. 12 or FIG. 13, the extending directions of the protrusion 82a, the protrusion 82b, the concave part 83a, the concave part 83b, and the concave part 84a are different each other. The protrusions 82a, 82b, and the concave parts 83a, 83b, 84a are the alignment controlling means formed on positions corresponding to the color elements 53, constituting a picture element, of respective colors. In other words, in pixels, constituting a picture element, of respective colors, the extending directions of the protrusion 82a, the protrusion 82b, the concave part 83a, the concave part 83b, and the concave part 84a which are the alignment controlling means are respectively set so as to appropriately set the alignment direction of the liquid crystal, which is regulated by the protrusions 82a, 82b and the concave parts 82a, 82b, 83a, in corresponding to each color. By respectively setting the extending directions of the protrusion 82a, the protrusion 82b, the concave part 83a, the concave part 83b, and the concave part 84a, which are the alignment means, in respective colors as mentioned, the alignment controlling means regulates the alignment direction of the liquid crystal, thereby being able to widen the viewing angle and realize an appropriate color balance in the widened viewing angle.

In the picture element shown in FIG. 12, FIG. 13, or FIG. 14, in pixels respectively including the color elements 53R, 53G, 53B which correspond to the color elements 53 of the three primary colors, the extending directions of the protrusion 82a, the protrusion 82b, the concave part 83a, the concave part 83b, and the concave part 84a are different from each other in corresponding to respective colors of the color elements 53. In other word, in pixels, constituting a picture element, of the light's three primary colors, the extending directions of the protrusion 82a, the protrusion 82b, the concave part 83a, the concave part 83b, and the concave part 84a which are the alignment controlling means are respectively set to so as to appropriately set the alignment direction of the liquid crystal, which is regulated by the protrusions 82a, 82b and the concave parts 83a, 83b 84a, in corresponding to each color. By respectively setting the extending directions in respective colors of the three primary colors as mentioned, the alignment controlling means regulate the alignment direction of the liquid crystal of pixels including the color elements of respective colors of the three primary colors, thereby being able to widen the viewing angle and realize an appropriate color balance in a color inside of a triangle formed by the light's three primary colors on a gamut, in the widened viewing angle.

In the picture element shown in FIG. 13 or FIG. 14, in pixels respectively including the color elements 53C, 53M, 53Y which correspond to the color elements 53 of the complementary colors of the three primary colors, the extending directions of the protrusion 82a and the protrusion 82b, and the like are different from each other in corresponding to respective colors of the color elements 53. In other words, in pixels, constituting a picture element, of the complementary colors of the light's three primary colors, the extending directions of the protrusion 82a, the protrusion 82b, and the like which are the alignment controlling means are respectively set in respective colors so as to appropriately set the alignment direction of the liquid crystal regulated by the protrusions 82a, 82b, and the like in corresponding to respective colors. By setting the extending directions in respective colors of the complementary colors of the three primary colors, the alignment controlling means regulate the alignment direction of the liquid crystal of pixels including the color elements of respective colors of the complementary colors of the three primary colors, thereby being able to widen the viewing angle and realize an appropriate color balance in a color inside of a triangle formed by the complementary colors of the light's three primary colors on a gamut, in the widened viewing angle.

In the picture element shown in FIG. 13 or FIG. 15, the extending directions of the protrusion 82a, the protrusion 82b, and the like in a pixel including the color element 53R corresponding to the color element 53 are respectively different from the ones in a pixel including the color element 53C corresponding to the color element 53 which is in complementary color relation to the color element 53R. The extending directions of the protrusion 82a, the protrusion 82b, and the like in a pixel including the color element 53G corresponding to the color element 53 are different from the ones in a pixel including the color element 53M corresponding to the color element 53 which is in complementary color relation to the color element 53G. The extending directions of the protrusion 82a, the protrusion 82b, and the like in a pixel including the color element 53B corresponding to the color element 53 are different from the ones in a pixel including the color element 53Y corresponding to the color element 53 which is in complementary color relation to the color element 53B. In other words, the extending directions of the protrusion 82a, the protrusion 82b, and the like in pixels constituting a picture element and having colors which are in mutually complementary color relation are set appropriately so as to set appropriately the alignment direction, which is regulated by the protrusions or a concave part, of the liquid crystal for a right balance between the colors. By setting extending directions of the protrusion 82a, the protrusion 82b, and the like in respective pixels having colors which are in mutually complementary color relation, the alignment controlling means regulate the alignment direction of liquid crystal, thereby being able to widen the viewing angle and realize an appropriate color balance in colors which are in mutually complement color relation, in the widened viewing angle.

In the picture element shown in FIG. 13 or FIG. 14, between colors of color elements 53 having same effective areas as each other, extending directions of the protrusion 82a, the protrusion 82b, and the like formed on positions corresponding to the color elements of respective colors are different from each other. In other words, the extending directions of the protrusion 82a, the protrusion 82b, and the like in pixels, having same effective areas as each other, of respective colors are adjusted so as to set appropriately the alignment direction, regulated by the protrusions and the like, of the liquid crystal for a right balance between the colors. By setting extending directions of the protrusion 82a, the protrusion 82b, and the like which are alignment controlling means in respective color elements 53 having same effective areas as each other, the alignment controlling means regulate the alignment direction of the liquid crystal in pixels respectively including the color elements having same effective areas as each other, thereby being able to widen the viewing angle and realize an appropriate color balance in a color inside of a polygon which is formed by colors having same effective areas as each other on a gamut, in the widened viewing angle.

In the picture element shown in FIG. 13 or FIG. 15, between the color elements 53 having different effective areas from each other, the extending directions of the protrusion 82a, the protrusion 82b, and the like formed on positions corresponding to the color elements of respective colors are different from each other. In other words, the extending directions of the protrusion 82a, the protrusion 82b, and the like in pixels, constituting a picture element and having different effective areas from each other, of respective colors are set appropriately so as to set appropriately the alignment direction, regulated by the protrusions and the like, of the liquid crystal for a right balance between the colors. Thus, in pixels including the color elements 53 having different effective areas from each other due to the alignment controlling means, by setting the extending directions of the protrusion 82a, the protrusion 82b, and the like which are the alignment controlling means in respective effective areas of the color elements 53, the alignment direction of the liquid crystal is regulated, thereby being able to widen the viewing angle and realize an appropriate color balance in the colors, in which an appropriate color balance can be obtained by changing an effective area, in the widened viewing angle.

An electronic apparatus according to a second embodiment of the invention will now be described. This electronic apparatus according to the present embodiment is equipped with the liquid crystal display according to the first embodiment. The electronic apparatus according to the present embodiment will be illustrated in detail.

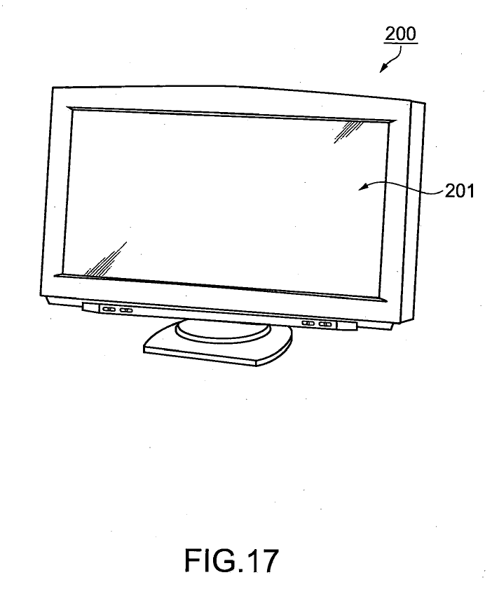

FIG. 17 is an external perspective view showing a large-sized liquid crystal television which is an example of the electronic apparatus. As shown in FIG. 17, a large-sized liquid crystal television 200 which is an example of the electronic apparatus includes a display part 201. The display part 201 includes the liquid crystal display 21 described in the first embodiment as a display means.

Now, advantageous effects of the second embodiment will be mentioned below. The large-sized liquid crystal television 200 includes the liquid crystal device, thereby being able to realize a good color balance and a wide viewing angle. The liquid crystal device controls an alignment direction of liquid crystal by the alignment controlling means to widen a viewing angle and sets individually the alignment direction depending in each color.

While the preferred embodiments according to the invention are described with reference to the accompanying drawings, an embodiment of the invention is not limited to the above embodiments. It is understood that the invention is not limited to the above-mentioned embodiments, but can be applied to various modifications without departing from the scope and spirit of the invention. The invention can be applied as follows.

Modification 1: In the embodiment, the liquid crystal panel provided with electrodes in stripe shape on the upper and lower substrates, but it is not indispensable that the display has a liquid crystal panel including electrodes in stripe shape. A thin film transistor panel in which a thin film transistor (TFT) is used to control a pixel, or a thin film diode panel in which a thin film diode (TFD) is used to control a pixel may be applied. In the TFT panel or the TFD panel, an element substrate provided with a TFT or a TED corresponds to the electrode substrate, a substrate facing the element substrate corresponds to a counter substrate.

Modification 2. In the above embodiments, the liquid crystal display having a multi-domain vertical alignment (MVA) system is illustrated, but the liquid crystal display may have an in-plane switching (IPS) system. In this case, a gap between electrodes adjacent each other is an alignment controlling means.

Modification 3: In the above embodiments, making a slit on pixel electrodes such as the first electrode 104, the second electrode 104b, and the first electrode 105a forms the concave part 83a, 83b, or 84a, but it is not indispensable to make a slit to form a concave part on the pixel electrodes. A material same as the one for forming a protrusion may layered on a whole surface except for one part so as to render the part a concave part.

Modification 4: In the above embodiments, it is described that extending directions of the alignment controlling means are different each other in all pixels of all color elements of the four-color filter, but not indispensable that the extending directions are different each other in all color elements. Such a structure is available that extending directions of the alignment controlling means are different each other in the color elements of at least three colors.

Modification 5: In the above embodiments, it is described that extending directions of the alignment controlling means are different each other in all pixels of the color elements 53 of all colors in the six-color filter, but not indispensable that the extending directions are different each other in the color elements 53 of all colors. Such a structure is available that extending directions of the alignment controlling means are different each other in the color elements of any three colors.

Modification 6: In the above embodiments, it is illustrated that the extending direction of the alignment controlling means are different each other between pixels having the color elements 53 of three primary colors, and the extending direction of the alignment controlling means are different each other between pixels including the color elements 53 of the color element 53 of the complementary colors of the three primary colors but it is not indispensable that the extending directions of the alignment controlling means are different each other between pixels having the color elements 53 of the three primary colors and between pixels having the color elements 53 of the complementary colors of the three primary colors. Such a structure may be available that the extending directions of the alignment controlling means are different between pixels having the color elements 53 of the three primary colors, or between pixels having the color elements 53 of the complementary colors of the three primary colors.

Modification 7: In the above embodiments, the protrusion 82a, the protrusion 82b, the concave part 83a, the concave part 83b, or the concave part 84a which is the alignment controlling means is provided on both of the first substrate 27a and the second substrate 27b, or both of the first substrate 127a and the second substrate 127b, but it is not indispensable that the alignment controlling means is provided on both of the first substrate and the second substrate. Such a structure is available that the alignment controlling means is provided on any one of the first substrate and the second substrate.

Modification 8: In the above embodiments, the four-color filter and the six-color filter are illustrated, but multi-color filters is not limited to the four-color filter or the six-color filter. The number of colors of the color elements may be any number which is four or more.

Modification 9: In the above embodiments, the color filter including the color elements 53 of four colors which are R (red), G (green), B (blue), W (white-clear) is described as a four-color filter, but colors of the four-color filter is not limited to R, G, B, W. The four-color filter may be a four-complementary-color filter including cyan, magenta, yellow, and green, or a four-color filter including other four colors.

Modification 10: In the above embodiments, the color filter including the color elements 53 of six colors which are R (red), G, (green), B (blue), cyan, magenta, and yellow is described as a six-color filter, but colors of the six-color filter is not limited to R, G, B, cyan, magenta, and yellow. The six-color filter may include color elements of other six colors.

Modification 11: In the above embodiments, it is described that the protrusions 82, the concave parts 83, or the concave parts 84 of which extending directions are different each other are formed in one color element 53, it is not indispensable that extending directions of the alignment controlling members included in one color element 53 have two kinds of directions. Extending directions of the alignment controlling members included in one color element 53 may include one kind, or three kinds or more.

Modification 12: In the above embodiments, the color filter is provided on the second substrate, but it is not indispensable. Such a structure is available that the color filter is provided on the first substrate. For example, a color filter may be provided on an element substrate formed a TFT in the TFT panel, or a color filter may be provided on a counter substrate facing the element substrate while interposing the liquid crystal layer in between.

Modification 13: In the above embodiments, forming the partition 56 provides the color element forming area 52, and filling color element material into the color element forming area 52 provides the color element 53, but it is not indispensable that the partition 56 is formed. Such structure may be available that the color elements 53 contact each other directly.

Modification 14: In the above embodiments, the droplet discharge method is used for forming the partition 56 or the color element 53, it is not indispensable that the partition 56 or the color element 53 is formed by the droplet discharge method. The partition 56 or the color element 53 may be formed by photolithography method, printing method, or other forming method.

Modification 15: In the above embodiments, the liquid crystal display which displays an image on the display surface of the apparatus is described as a liquid crystal device, but the invention may be applied to apparatuses used liquid crystal such as a liquid crystal projector and the like other than the liquid crystal display which displays an image on the display surface of the apparatus.

Modification 16: In the six-color filter of the above embodiments, areas of color elements 53C, 53M, 53Y of cyan (C), magenta (M), yellow (Y) which are complementary colors of R, G, B which are light's three primary colors are smaller than the ones of color elements 53R, 53G, 53B of R, G, B, but it is not indispensable. Areas of color elements 53C, 53M, 53Y may be larger than areas of color elements 53R, 53G, 53B, or they may have same areas.

Modification 17: In the above embodiments, the shape of the color element 53, i.e. the shape of pixel is rectangular and the shape of the picture element composed of pixels is also rectangular, but the shape of the pixel or the picture element is not limited to rectangle. For example, such structure is available that the pixel is triangular and the triangular pixels are combined to form a triangular, trapezoidal, or hexagonal picture element, or the pixel is hexagonal and the hexagonal pixels are combined to form a picture element. In addition, such structure is also available that pixels in different shapes each other are combined to form a picture element.

Modification 18: In the above embodiment, the picture element filters 54, 57 have one color element 53 each for one color of the colors they have, it is not indispensable that the color element constituting one picture element is one for one color. Such structure is available that a plurality of color elements having same color are provided and dispersed to be disposed in one picture element filter.

The entire disclosure of Japanese Patent Application No. 2006-42007, filed Feb. 20, 2006 is expressly incorporated by reference herein.

What is claimed is:

1. A liquid crystal device, comprising;
an electrode substrate including a plurality of pixel electrodes;
a counter substrate facing the electrode substrate;
a color filter including a color element facing each of the plurality of pixel electrodes;
a liquid crystal supported between the electrode substrate and the counter substrate; and
an alignment controlling means extending on a face, the face contacting the liquid crystal, of at least one of the electrode substrate and the counter substrate;
wherein the color element has four or more colors; and an extending direction of the alignment controlling means formed on a position corresponding to the color element of any color of at least three predetermined colors of the four or more colors is determined in each color, and is different in each color.

2. The liquid crystal device according to claim 1, wherein an extending direction of the alignment controlling means formed on a position corresponding to the color element of a color other than the predetermined colors is determined in each color, is different in each color, and is different from an extending direction of the alignment controlling means formed on the position corresponding to the color element of any color of the predetermined colors.

3. The liquid crystal device according to claim 1, wherein the predetermined colors are red, green, and blue which are three primary colors.

4. The liquid crystal device according to claim 3, wherein an extending direction of the alignment controlling means formed on a position corresponding to the color element of a color other than the three primary colors is determined in each color, and different in each color.

5. The liquid crystal device according to claim 1, wherein the predetermined colors are any of cyan, magenta, and yellow which are complementary colors of red, green, and blue which are the three primary colors.

6. The liquid crystal device according to claim 5, wherein an extending direction of the alignment controlling means formed on a position corresponding to the color element of a color other than the complementary colors of the three primary colors is determined in each color, and different in each color.

7. A liquid crystal device, comprising;
an electrode substrate including a plurality of pixel electrodes; a counter substrate facing the electrode substrate;
a color filter including a color element facing each of the plurality of pixel electrodes;
a liquid crystal supported between the electrode substrate and the counter substrate; and
an alignment controlling means extending on a face, the face contacting the liquid crystal, of at least one of the electrode substrate and the counter substrate;
wherein the color element has a color of red, green and blue which are three primary colors, and cyan, magenta, and yellow which are complementary colors of the three primary colors; an extending direction of the alignment controlling means formed on a position corresponding to the color element of any color of the three primary colors is determined in each color, and different in each color; and an extending direction of the alignment controlling means formed on a position corresponding to the color element of any color of the complementary colors of the three primary colors is determined in each color, and different in each color.

8. A liquid crystal device, comprising;
an electrode substrate including a plurality of pixel electrodes; a counter substrate facing the electrode substrate;
a color filter including a color element facing each of the plurality of pixel electrodes;
a liquid crystal supported between the electrode substrate and the counter substrate; and
an alignment controlling means extending on a face, the face contacting the liquid crystal, of at least one of the electrode substrate and the counter substrate;
wherein the color element has a color of red, green and blue which are three primary colors, and cyan, magenta, and yellow which are complementary colors of the three primary colors; an extending direction of the alignment controlling means formed on a position corresponding to the color element is determined in each color, and an extending direction of the alignment controlling means formed on a position corresponding to the color element of a first color is different from an extending direction of the alignment controlling means formed on a position corresponding to the color element of a second color which is in a complementary color relation to the first color.

9. A liquid crystal device, comprising;
an electrode substrate including a plurality of pixel electrodes; a counter substrate facing the electrode substrate;
a color filter including a color element facing each of the plurality of pixel electrodes;
a liquid crystal supported between the electrode substrate and the counter substrate; and
an alignment controlling means extending on a face, the face contacting the liquid crystal, of at least one of the electrode substrate and the counter substrate;
wherein the color element includes a first color element having a first area of an effective area through which light transmits, and a second color element having a second area of the effective area; and an extending direction of the alignment controlling means formed on a position corresponding to at least one of the first color element and the second color element is determined in each color, and different in each color of the first color element or in each color of the second color element.

10. A liquid crystal device, comprising;
an electrode substrate including a plurality of pixel electrodes; a counter substrate facing the electrode substrate;
a color filter including a color element facing each of the plurality of pixel electrodes;
a liquid crystal supported between the electrode substrate and the counter substrate; and
an alignment controlling means extending on a face, the face contacting the liquid crystal, of at least one of the electrode substrate and the counter substrate;
wherein the color element includes a first color element having a first area of an effective area through which light transmits, and a second color element having a second area of the effective area; and an extending direction of the alignment controlling means formed on a position corresponding to the first color element or the second color element is determined in each color, and an extending direction of the alignment controlling means formed on a position corresponding to the first color element and an extending direction of the alignment controlling means formed on a position corresponding to the second color element are different from each other.

11. The liquid crystal device according to claim 7, wherein an extending direction of the alignment controlling means formed on a position corresponding to the color element is determined in each color, and is different in each color of the color element.

12. The liquid crystal device according to claim 1, wherein an extending direction of the alignment controlling means includes a first extending direction and a second extending direction; and the alignment controlling means corresponding to the single color element includes both of the alignment controlling means extending in the first extending direction and the alignment controlling means extending in the second extending direction.

13. The liquid crystal device according to claim 1, wherein the alignment controlling means is a protrusion formed on a face contacting the liquid crystal or a concave part formed on a face contacting the liquid crystal.

14. The liquid crystal device according to claim 13, one of the protrusion and the concave part, or both of the protrusion and the concave part are provided in corresponding to each of the color element.

15. The liquid crystal device according to claim 13, the concave part is formed by providing a slit to the pixel electrode.

16. The liquid crystal device according to claim 1, the alignment controlling means is a gap between the pixel electrodes adjacent each other.

17. An electronic apparatus, comprising:
the liquid crystal device according to claim 1.
